(19) United States
(12) Patent Application Publication
(10) Pub. No.: US 2018/0020093 A1
(43) Pub. Date: Jan. 18, 2018

(54) AUTOMATED CALL ANSWERING BASED ON ARTIFICIAL INTELLIGENCE

(71) Applicant: CIRCLE RIVER, INC., New York, NY (US)

(72) Inventors: Adam BENTITOU, New York, NY (US); David MANSFIELD, New York, NY (US); Robert LIPPMAN, New York, NY (US)

(21) Appl. No.: 15/649,131

(22) Filed: Jul. 13, 2017

Related U.S. Application Data
(63) Continuation-in-part of application No. 15/211,120, filed on Jul. 15, 2016.
Application No. 15/211,120 is a continuation-in-part of application No. 15/241,513, filed on Aug. 19, 2016.
Application No. 15/241,513 is a continuation-in-part of application No. 15/241,555, filed on Aug. 19, 2016, now Pat. No. 9,736,309.
(60) Provisional application No. 62/419,961, filed on Nov. 9, 2016.

(51) Int. Cl. H04M 3/436; H04M 3/42; G10L 15/18; H04M 3/527; G10L 25/63; G10L 15/08

(52) U.S. Cl. CPC H04M 3/4365; H04M 3/527; G10L 25/63; H04M 3/42221; H04M 3/42382; G10L 15/1815; G10L 2015/088; H04M 2201/39; H04M 2201/40; H04M 2201/60; H04M 2203/306

(57) ABSTRACT

A method of processing a telephone call from a calling party in order to determine the disposition of the call. Certain details of an incoming call or of the calling party are obtained by artificial intelligence conversations with the calling party, wherein the artificial intelligence communicates with the calling party automatically and independently. The artificial intelligence then determines how to process the call based on the certain details obtained during the conversations with the calling party along with separate call processing criteria that is provided to the artificial intelligence. Thus, the artificial intelligence can automatically determine to process the call by appropriately forwarding or not forwarding the call, providing a message or response to the calling party, taking a message from the calling party and appropriately forwarding it to the particular person, to voice mail, or to another person of the business entity, or disconnecting or terminating the call.

### CROSS-REFERENCE TO RELATED APPLICATIONS

This application is a continuation-in-part of U.S. application Ser. No. 15/211,120 filed Jul. 15, 2016, and a continuation-in-part of U.S. application Ser. No. 15/241,513 filed Aug. 19, 2016, and a continuation-in-part of U.S. application Ser. No. 15/241,555 filed Aug. 19, 2016, and claims the benefit of U.S. application Ser. No. 62/419,961 filed Nov. 9, 2016, the entire content of each of which is expressly incorporated herein by reference thereto.

### FIELD OF THE DISCLOSED TECHNOLOGY

The disclosed technology relates generally to automated call answering and, more specifically, to the use of artificial intelligence to process incoming telephone calls by directly and automatically conversing with the caller and comparing the details received with certain call processing criteria that is provided to the artificial intelligence either before the call is received, or during the call via real-time audio or transcription and communication via receipt of the transcription and conditional forwarding of calls.

### BACKGROUND OF THE DISCLOSED TECHNOLOGY

With the advent of communications technology, many individuals have opted to replace their conventional land line telephones with mobile devices such as mobile phones, PDAs, and tablet computers. Although these devices are a great convenience, some problems associated with conventional telephones still remain. Unwanted telephone calls (e.g., solicitation calls) are still frequently received by both the conventional land lines and mobile devices. Thus, it would be desirable to have a technique that can help recipients of telephone calls decide whether to take an incoming call or not.

Several existing methods and systems have tried to address the aforementioned problems. One resolution is incorporating a recognition software or hardware into the mobile device. The recognition software/hardware enables identification of the calling party's telephone number and/or identity and the user can decide whether or not he or she should answer the call upon viewing and determining the number and/or identity whether recognizable. This technique, however, has becoming futile because there are programs that enable such callers to block their identification information. Another resolution is not answering the call and let the call goes to voice mail. Voice mail screening, however, adds a time delay to determine the subject matter of voice message as a callee usually access the content of the voice mail only after the caller has completed a recording a message. The called then dials the caller to complete communication between the two parties.

U.S. publication 2015/0103983 to Kilmer discloses an application for screening incoming calls. Upon receiving a call, the application allows the receiving party to switch the call to an audio receptionist routine that is programmed to inquire the identity of the calling party and to provide the obtained information to the receiving party. The information may be obtained through a speech recognition routine that converts verbal information received from the calling party into text for visual display to the receiving party. The transcribed text can be displayed in real-time. During this period, the application provides the receiving party's mobile device with a menu screen having multiple, user-selectable options for handling the call such as answering the call, sending the call to voicemail, and terminating the call.

U.S. Pat. No. 8,243,888 to Cho discloses a controller for transcribing a phone conversation into text and saving the transcribed conversation in memory. The transcribed conversation can also be displayed in real time.

U.S. Pat. No. 8,447,285 to Bladon et al. discloses a method of converting a voice communication from a telephone call to text and storing or forwarding portions of the text to an intended recipient or particular person. Additionally, the text is analyzed to identify portions that are inferred to be relatively more important to communicate to the intended recipient. This is used to analyze voice mail messages so that the intended recipient can more quickly determine what the message concerns without having to listen to the entire message.

U.S. Pat. No. 8,655,662 to Schroeter discloses a system and method for answering a communication to a user, e.g., a telephone call, by receiving a notification of the communication, converting information related to the communication into speech information and outputting the speech information to the user so that the user can provide a vocal instruction to accept or ignore the incoming communication associated with the notification.

U.S. patent 2009/0104898 to Harris discloses a server that can make decisions based on certain criteria that is stored in a database as to whether calls should be allowed to ring and/or be answered. Voice recognition can be used to recognize the caller and to send this information to the intended recipient's communication device.

None of these technologies, however, enables screening incoming calls automatically and intelligently without requiring input from the called party, or by allowing the called party to view the calling party's message in real-time, and allowing the called party to modify the screening process in real-time. Accordingly, there remains a need for methods and systems that are improved over what is currently known in the art.

### SUMMARY OF THE INVENTION

The invention relates to a method of processing a telephone call from a calling party in order to determine the disposition of the call, which comprises receiving a telephone phone call from the calling party that is directed towards a particular person or business entity; obtaining certain details of the call or calling party by artificial intelligence conversations with the calling party, wherein the artificial intelligence communicates with the calling party automatically and independently; and determining by the artificial intelligence how to process the call based on the certain details obtained during the conversations with the calling party along with separate call processing criteria that is provided to the artificial intelligence, so that the artificial intelligence can automatically determine to process the call by (a) forwarding the call to the particular person or to voice mail, or (b) forwarding the call to another person of the business entity or to a third party, or (c) providing a message or response to the calling party, party, (d) taking a message from the calling party and appropriately forwarding the message to the particular person, to voice mail, or to another person of the business entity, or (e) disconnecting or terminating the call.

In this invention, the artificial intelligence processes the call by forwarding the call to the particular person, taking a message from the calling party and providing the response or message to the particular person, providing a message from the particular person to the calling party, directing the call to voice mail, directing the call to another person or a third party, scheduling a meeting or callback on behalf of the particular person, receiving a reminder for the particular person, or terminating the call without requiring input from the particular person after the call is answered.

The details that are typically obtained by the artificial intelligence include one or more of voice recognition of the calling party, or by an identification of the calling party's telephone number, the calling party's location, the calling party's name, the calling party's organization, the purpose of the calling party's call, or call content based on a keyword, password, a detection of importance or urgency, or other call description. Thus, the determination of the disposition of the call can be based on a comparison of the obtained certain details to information that is available to, was provided to or is known by the artificial intelligence.

When the calling party is seeking to reach the particular person and the determination of call forwarding by the artificial intelligence is at least partially based on whether the particular person is available or not, wherein the call is not forwarded to the particular person by the artificial intelligence when the particular person is not available. Also, the availability of the particular person can be determined by a calendar, by a notification on the particular person's computer or telephone that is accessible by the artificial intelligence, by determining that the particular person is currently on a phone call, by determining that the particular person is at a particular location, by determining that the particular person is historically unavailable at the time of the received call, or by a notification to the artificial intelligence from the particular person or based on other conditions provided to the artificial intelligence prior to the call or determined by the artificial intelligence from prior call processing. Preferably, the notification to the artificial intelligence from the particular person is through an app residing on the particular person's telephone or computer.

Additionally, the determination of call forwarding to the particular person when the particular person is available, is based on obtaining details that include detecting an elevated importance in the call from the calling party. For this, the detecting of the elevated importance can be based on a keyword within the text which has been pre-designated as a keyword which indicates elevated importance, or is based on voice or speech recognition which includes caller tone or speed of speech above a pre-defined threshold indicating the elevated importance or is detected by the artificial intelligence determining through semantic analysis that elevated importance exists. And when elevated importance is detected and the particular person is known to the artificial intelligence to be available, the artificial intelligence automatically forwards the call to the particular person, and when elevated importance is not detected, the artificial intelligence does not forward the call to the particular person.

The method can also include having the artificial intelligence forwarding an intent to forward the call to a bidirectional transceiver associated with the particular person; and receiving data from the particular person indicating that the particular person is not available or does not wish to receive the call; wherein the artificial intelligence then denies forwarding the call to the particular person. Alternatively, when the call is determined to be from an authorized calling party based on caller identification information or by artificial intelligence conversations with the calling party, the call is directly forwarded to the particular person when the person is available.

In comparison, when the call is determined to be from an unauthorized calling party based on a match of caller identification information or on the separate call processing criteria that is provided to the artificial intelligence, wherein the artificial intelligence terminates the call, forwards the call to voice mail or takes a message.

Another embodiment of the invention relates to the method transcribing audio between the calling party and the artificial intelligence into text and forwarding the text in real time to the particular person to allow the person to assist the artificial intelligence in processing the call. The recorded audio between the artificial intelligence and the calling party or the conversations themselves be used to generate a transcript which is forwarded to the particular person for present or future action in deciding whether to answer or return the call or not or take other action.

The method can also include forwarding in real time some or all of the obtained certain details to the particular person; wherein the particular person can override the determination made by the artificial intelligence based on a review of the forwarded details that are provided in real time to the particular person. This can instead include forwarding in real time some or all of the obtained certain details to a monitoring person who can assist the artificial intelligence in obtaining details or making the determination by communicating with the artificial intelligence so that the call may be properly processed.

Another aspect of the invention relates to a network switch, comprising: at least one phone network interface which receives phone calls at a first network node; a physical storage medium which stores audio from the phone calls; a speech recognition engine which transcribes at least some of the audio from the phone calls; a transcription engine which transcribes at least some of the audio from the phone calls; and a packet-switched data network connection which transmits audio output of at least one of: text to speech synthesis; and pre-recorded audio to a calling party of the telephone call. The audio output comprises responses based on output of the transcription engine; and while transcribing the at least some of the audio of the telephone call, sending the transcription to a bidirectional transceiver at a second network node in real-time.

The audio output can be based partially on artificial intelligence and partially on instructions received from the bidirectional transceiver receiving the transcription; wherein data are transmitted via the packet-switched data network to the bidirectional transceiver causing a plurality of selectable elements to be exhibited on the bidirectional transceiver, wherein the selectable elements are based on preceding conversation between the calling party and the artificial intelligence.

Also, a selectable element of the selectable elements advantageously comprises at least one selector which, when selected, causes the call to be forwarded to another network node or particular person; causes future calls from the calling party received at the first network node to be forwarded to the bidirectional transceiver, bypassing the step of the creating the transcription; causes future calls from the calling party to carry out the step of the receiving the phone call at the first network node and the using speech recognition while skipping or suppressing the step of sending the transcription to the bidirectional transceiver; or comprise selections related to time.

The text input from the bidirectional transceiver may be received via the packet-switched data network connection; and plays a speech synthesized version of the text input as part of the audio output, or converts the audio input to text and a speech synthesized version of the audio input, based on the text, is exhibited over the phone network, such that the speech synthesized version matches a voice of the speech synthesis in the audio output.

Another aspect of the apparatus is a telephone switch comprising at least one telephone network node and at least one network connection with a bidirectional transceiver, which: receives a phone call at the at least one network node; uses speech recognition to create a transcription of audio of the telephone call; while creating the transcription of audio of the telephone call, sends the transcription to the bidirectional transceiver in real-time via the at least one network connection; during said phone call, transmits audio output of at least one of text to speech synthesis or pre-recorded audio to a calling party via said at least one network node based on information provided by the calling party and instructions received from said bidirectional transceiver receiving said transcription; and directs the call or responds to the calling party based on the information provided by the calling party and instructions received from said bidirectional transceiver.

For the use of speech recognition, a processor on the telephone switch determines that the calling party wants to schedule a meeting, and the instructions received from the bidirectional transceiver include a date and time for the meeting. The instructions received from the bidirectional transceiver indicate that a particular person is unavailable and a proposed time for the particular person to place a new telephone call to the calling party, the instructions further comprising the proposed new time.

Preferably, the bidirectional transceiver, while receiving the transcription (a) sends instructions to the first network node to end the telephone call; and the telephone call is disconnected from the first network node; or (b) sends instructions to the first network node to forward the phone call to the called party or a third party.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 is a high level block diagram of devices which are used to carry out embodiments of the disclosed technology;

FIG. 2 is a high level flow chart depicting how calls are answered, transcribed, and manipulated, in embodiments of the disclosed technology;

FIG. 3 is a high level flow chart of interactions between a telecommunications switch and a bi-directional transceiver, in embodiments of the disclosed technology;

FIG. 4 depicts a bi-directional transceiver of a second party with real-time transcription and selectable elements used to interact with a calling party, in embodiments of the disclosed technology;

FIG. 5 is another a high level block diagram of devices which are used to carry out embodiments of the disclosed technology;

FIG. 6 is a high level flow chart depicting how calls are forwarded to a called party when they are urgent, in embodiments of the disclosed technology;

FIG. 7 is a high level flow chart which depicts further aspects of determining importance or urgency, in embodiments of the disclosed technology;

FIG. 8 shows a high-level block diagram of a device that may be used to carry out the disclosed technology;

FIGS. 9-13 show another high level example of how a call is answered, transcribed, and manipulated, in embodiments of the disclosed technology; and

FIGS. 14-22 show an illustrative module residing on the called party's transceiver that is implemented to configure the artificial intelligence, in embodiments of the disclosed technology.

### DETAILED DESCRIPTION

Embodiments of the disclosed technology are described below, with reference to the figures provided. For purposes of this disclosure, “speech recognition” is defined as “making a determination of words exhibited aurally.” Further, “voice recognition” is defined as “making a determination as to who is the speaker of words.”

Generally, artificial intelligence is used to process incoming telephone calls by directly and automatically conversing with the caller and comparing the details received from the caller with certain call processing criteria that was previously provided to the artificial intelligence. The call processing criteria may be provided before the call is received, but can be overridden with further instructions provided to the artificial intelligence by the person being called (the “callee”) or by another person or a monitor of the artificial intelligence.

The call processing criteria provided to the artificial intelligence can be instructions for processing calls that are anticipated to be received by the callee. For example, the artificial intelligence can be provided with information from the callee that a particular call of importance, e.g., a message from the callee's bank regarding the callee's application for a mortgage, when received should be immediately directed to the callee by the artificial intelligence. The call can be forwarded to the callee with a message that indicates that the call is from the callee's bank. This can be done by providing a phone number or caller ID to the artificial intelligence. The artificial intelligence can also recognize that the call is important by determining that the phone number or caller ID is not the same as what was provided but is form the same exchange or from another party at the bank. And in the situations where there is no caller ID, the artificial intelligence can converse with the calling party to determine or confirm that the call is coming from the callee's bank and that is the important call that the callee is expecting prior to forwarding. The conversation can also determine whether the call is the correct one rather than a cold call from the bank to offer some type of additional service that is not related to the callee's mortgage application.

The call processing criteria to be provided to the artificial intelligence can include a message that the artificial intelligence can include in a response to a known or expected caller. For example, the callee can inform the artificial intelligence to provide a message to an expected or anticipated caller that a meeting should be rescheduled or that the callee would conform taking certain action or his or her attendance at a certain meeting or event.

Some of the embodiments of the disclosed technology are related to artificial intelligence communication with caller and real-time transcription and manipulation thereof. Receiving a telephone call to an auto-attendant, artificial intelligence, or person takes place. While this phone call is being conducted, a speech to text transcription can be created and sent in real-time to the callee or another person at another network node. This person can read the transcript and interact with the phone call by sending his or her own commands, text, or speech to be made part of the phone call.

Accordingly, the methods and apparatus of the present invention utilize the artificial intelligence to determine who the caller is and what they want to do while also comparing that information, which the artificial intelligence collects from caller identification or conversations with the caller, with call processing criteria from or about the callee, such as calendar data, travel information, or particular desires or instructions from the callee or a monitor (e.g., the callee's secretary or administrative assistant), in order to determine how to process the call. And when information regarding the call is provided to the callee or monitor from the artificial intelligence by a transcript, audio or other forwarded information as the conversations progress between the caller and artificial intelligence, the callee or monitor can override previous call processing instructions or instruct the artificial intelligence to process the call differently than it would do otherwise. All of this allows incoming calls to be efficiently and effectively processed in an ordered fashion and automatically, with potential options for overriding or changing previous instructions seamlessly and in real time.

For purposes of this disclosure, “artificial intelligence” is defined as a computer system configured to exhibit human cognitive functions such as learning (the acquisition of information and rules), reasoning (applying the rules to the acquired information to reach conclusions), and self-correction (changing the reached conclusion to another conclusion if the reached conclusion is incorrect). The computer system is a combination of a tangible storage device, processor, and other hardware components that carry out instructions to imitate the manners in which a human receives audio or text, processes the received audio or text, and provides a response related to the audio or text. The response is one that would have been provided by the callee if the callee were given the same audio or text or one that aligns with the callee's thinking. Further, for purposes of this disclosure, a “bidirectional transceiver” is a device which can send/transmit and receive data via wired or wireless communication, using a circuit-switched or packet-switched method of data communication. Further, “real-time” is defined as, during the conversation, without any intentional delay, and substantially as fast as the devices and communication methods used can physically process and send the data. In embodiments, “real-time” is less than five seconds, three seconds, or one second from completing transcription of a block of text, until the text is exhibited on a bi-directional transceiver. A “network node” is defined as a physical location on a network where a signal is received and interpreted or rebroadcast.

In one preferred aspect, the invention relates to a method of receiving a telephone call is carried out by way of receiving a phone call at a first network node. Then, by use of speech recognition, a transcription of an audio of the telephone call is created. This can include audio from both sides of the conversation (the calling party and the party who answered the call, who, in embodiments of the disclosed technology is an artificial intelligence) or just the calling party, as the transcript of the audio played over the phone call by the called party is already known. In either case, while creating the transcription of an audio of the telephone call, the transcription is sent to a bidirectional transceiver at a second network node, in real-time.

While the conversation between the calling party and the artificial intelligence is taking place through a series of audio between the parties and transcription thereof, the bidirectional transceiver at another network node can interact with the call, acting on the part of, or effecting the called party/artificial intelligence. This can be in the form of receiving instructions from the bidirectional transceiver to send the telephone call to the second network node, whereby the call is sent and is now forwarded to, and answered at, the bidirectional transceiver. This can happen before, during or after carrying on the conversation with the calling party via converting text to speech, or by playing pre-recorded audio clips, or some combination thereof.

While or after the call is going on, and the bi-directional transceiver is receiving a real-time transcript, the audio of the call can be outputted to the bi-directional transceiver based on a request received there-from. Or, the call can be transferred in its entirety to the bi-directional transceiver. The transcription may continue or may cease at this time, and the call, in some embodiments, can be sent entirely back to the artificial intelligence at the second network node to continue the call. Still further, the bi-directional transceiver may send instructions to forward the call to a third network node, such as one associated with, or which will be answered by, an entirely different person or entity. For example, on a technical support call, the second network node might be monitoring a plethora of call transcripts and realize a certain call needs to be elevated to someone with more experience/a human being, and so such instructions will be sent, the calling party will be notified by the artificial intelligence, and the call will be transferred. The audio can remain/be sent to the second network node for monitoring while the call is actually handled by the third network node.

The bi-directional transceiver can also modify the output of the audio in the call by way of receiving speech, text, or on-screen selection at the bi-directional transceiver, which is interpreted, and/or transmitted, in audio form into the phone call to the calling party. This can be included, for example, using the speech recognition to determine that the calling party wants to schedule a meeting and, using instructions received (via audio input, text input, or an on-screen selection) from the bidirectional transceiver include a date and time for the meeting to suggest and/or schedule the meeting. Such a meeting can be via phone, video conference, or in person. Thus, if applicable, a place of meeting can also be confirmed using this method of communication. This can be as a result of determining that a called party is unavailable (based on the afore-described methods of entry, which in this case, can take place before the phone call or during).

Audio received into the bi-directional transceiver can be played directly into the call in embodiments. In other embodiments, the audio played in the call is as a result of speech recognition of audio from the bi-directional transceiver, which is then subject to text to speech synthesis, such that the same voice of the artificial intelligence is used for the speech received from the live person at the second network node/bi-directional transceiver.

Other commands which can be received from the bi-directional transceiver, using the above-described input and transmission methods, include disconnecting the call, forwarding the call to a third party, and forwarding the call to the second network node/bi-directional transceiver based on detecting an urgent condition as part of an automatic process of detecting a particular keyword, or the like indicating importance or urgency. The detecting step, and in particular the detecting of urgency or elevated importance of a call, is performed by a trained AI.

A telephone switch having at least one telephone network node, and at least one network connection with a bidirectional transceiver, is also part of the disclosed technology. It receives calls, has a speech recognition engine, a transcription engine and telephone, as well as other wired and/or wireless network connections, including such as for internet protocol networks.

In further embodiments of the disclosed technology, artificial intelligence is used when receiving a telephone call in the following manner. The call is received to a first network node and, based on speech recognition of audio received from the calling party, a transcription of such audio is created. Audio output, which is, at least in part, formed as a response to the calling party as part of a conversation (defined as, “what a person of ordinary skill in the art would recognize as give and take between two parties such that each party gains at least some previously unknown information from the other party”) is transmitted into the phone call. This audio output is created by at least one of text to speech synthesis or playing pre-recorded audio appropriate for having the conversation. While creating the transcription of at least some of the audio of the telephone call (at the same moment in time and/or in real-time), the transcription is sent to a bi-directional transceiver at a second network node.

The audio output played into the phone call at the called party end (receiving or second network node) can be partially based on artificial intelligence and partially on instructions received from the bidirectional transceiver which is receiving the transcription. The latter can be effectuated by sending data to the bidirectional transceiver sufficient to cause a plurality of selectable elements to be exhibited on the bi-directional transceiver. These selectable elements (e.g., buttons displayed or exhibited on a screen) can be based on preceding conversation between the calling party and the artificial intelligence (i.e., specific selectable elements or only selectable elements relevant to preceding conversation can be displayed). These selectable elements can also be displayed without regard to the conversation between the artificial intelligence and the calling party (i.e., general selectable elements that apply to all conversations).

Such selectable elements (and actions carried out/resulting corresponding audio in the conversation) can include one, or a plurality of: a) causing the call to be forwarded to another network node or called party, b) causing future calls determined to be from the same calling party (such as by comparing caller identification, voice recognition, or other data) received at the first network node to be forwarded to the bidirectional transceiver, bypassing the step of said creating said transcription, c) causing future calls from the calling party to converse with the artificial intelligence without any transcription/notification to the bi-directional transceiver, and d) schedule a meeting (via the artificial intelligence). “Preceding conversation” is defined as a portion of the conversation or the entire conversation between the calling party and the artificial intelligence before the selectable elements are displayed. These selectable elements can be displayed before the conversation between the artificial intelligence and the calling party or the transcription process occurs or at any given time during that conversation or process. The selectable elements displayed on the bidirectional transceiver can change as the conversation between the artificial intelligence and the calling party or the transcription progresses.

The disclosed technology further concerns when to forward a phone call to a called party. When the called party indicates that he/she is available, the call is sent to the called party in more instances than when the called party indicates that he/she is unavailable. In fact, being “unavailable,” for purposes of this disclosure, is defined as indicating a desire to, and/or sending instructions to, accept fewer phone calls than in an “available” state. The fewer phone calls accepted are based upon one or more parameters, such as only accepting urgent calls. Urgent calls or call importance or urgency is determined based on factors described herein below. It should also be understood that “phone call” can refer to phone calls over a public-switched telephone network, a private telephone network, and/or any method of sending/receiving audio between two devices. For purposes of this disclosure, “phone” is used to refer to all such instances. “Phone call” and “call” are used interchangeably in this disclosure.

In embodiments of the disclosed technology, a phone call is sent to a device associated with the called party, which is defined as a caller attempting to reach a particular person or entity associated by way of a direct inward dial number (DID), associated alias or user identification, or the like. The called party uses a bidirectional transceiver (a device which receives and sends electrical impulses whether wired or wireless), which is referred to together as the “called party,” meaning the person who controls, or is associated with, the device and/or DID, or the like. The call directed to the called party is received at a network node, where the calling party is determined based on one or both of call identification information or voice recognition. The call identification information can be provided as digital information out of band with the audio of the phone call (for example, the calling line identification or CallerID protocol, as well as the automatic number identification (ANI) protocol). Or the call identification information can be provided by the calling party during the phone call, such as being prompted for, and responding with, a name. Voice recognition can be used in conjunction there-with to match the calling party to previous calling parties.

A determination is then or previously made that the called party is unavailable, and this is indicated to the calling party via audio within the phone call. A further or prior conversation with the calling party ensues at the network node, such as with an interactive voice response (IVR) system known in the art, where a synthesized digital voice or prerecorded voice interacts with the calling party. Urgency is detected in the voice of the calling party using voice recognition and determinations within the voice such as volume, change in volume, tone, speed, anger, keywords and other factors. Based on such urgency, the call is forwarded to the called party when the called party indicated that he/she is available. In some embodiments of the disclosed technology, the call is forwarded to the called party despite the calling party indicating that he/she is unavailable. In other embodiments, even though urgency is detected the call is not forwarded to the bidirectional transceiver associated with the called party.

In some embodiments, an additional step of transcribing audio within the phone call, such as audio of the calling party which then is sent by a device associated with the calling party (e.g., a bidirectional transceiver) is conducted. The text itself is used to determine urgency or importance based on predesignated keywords (e.g., “dead,” “death,” “school nurse,” etc.) in the text which indicates urgency. This can further be based on a combination of tone and speed of speech above a predefined threshold indicating urgency.

As described above, in some cases even when urgency is detected, the phone call is not forwarded to the called party. This can happen when the call identification information matches a predesignated call identification information on a blacklist. Further, different calls can be compared to one another, so that, if any information related to a first phone call which was forwarded and the called party sent data or indicated a desire not to receive even “urgent” calls from the particular calling party or at a particular time, then this calling party is not forwarded to the called party in another phone call. This same calling party can be determined (and then denied forwarding) based on a voice recognition match or caller identification match, indicating it's the same calling party. The call being forwarded to the called party might also be denied due to a keyword in a transcript of phone call matching a negative keyword (e.g., “mistress,” “Belgium,” or “offer”). In some embodiments, the comparison of different calls is not necessary and the called party can simply send data or indicate a desire not to receive urgent calls.

An additional step of forwarding the call, which is a first call, to the bidirectional transceiver associated with said called party, based on the detecting of importance or urgency, is carried out in embodiments. Then, data are received from the called party, indicating that the forwarding of the call was desired or undesired. These data can be in the form of entry into the bidirectional transceiver (DTMF tones (dualtone multifrequency signaling), responded to a displayed query on a display device with an input device such as touchscreen of the bidirectional transceiver, or the like). The data can also be in the form of making a determination based on the called party's voice (e.g., anger) determined as part of speech recognition, accelerometer report from the phone (e.g. throws the phone down versus gently places it back in his pocket), or length of time he/she remains on the call (e.g., hangs up after 10 seconds compared to an average call length of 10 minutes).

The aspects of the first and second call which might lead to comparing the two and making a determination as to whether to forward or not forward the second call can be one or more of grammar and/or syntax (does the person speak with proper American grammar, British grammar, ebonics, or some form of improper grammar), common keywords (e.g., both callers say an unusual word in the English language specific to the called party, such as “patent” to a patent attorney, which is learned as a desired word for forwarding the call), or the like. Further, location of the calling party, determined by callerID, ANI, or provided via speech during the course of the call, might be a determining factor to compare and do likewise for the second call as the first. Speaking tone and speaking speed may also be a factor (the called party may only want to accept calls when unavailable from female callers, even if he/she is unaware of this practice). Tonal and speed changes from a first time period in the call (e.g., beginning of the call) compared to a second time period (e.g., after second question presented to the calling party) may also factor into the comparison. The time until the calling party reaches the threshold of “urgent” in the call may also be a factor, such as if it took the first caller a minute into the call to reach the urgency threshold, and this was found to be an undesired forward to the called party, a maximum time for such urgent calls in the future is reduced.

The invention also relates to a method of processing a telephone call from a calling party in order to determine whether the call should be forwarded, The method comprises receiving a telephone phone call from the calling party that is directed towards a particular person or business entity; obtaining certain details of the call or calling party by artificial intelligence; and determining by the artificial intelligence how to process the call including whether the call should be forwarded to the particular person or another person of the business entity based on the obtained details of the call or calling party and call processing criteria associated with the artificial intelligence. The artificial intelligence then can process the call by forwarding the call to the particular person, taking a message from the calling party, directing the call to voice mail, directing the call to a third party, scheduling a meeting or callback on behalf of the particular person, receiving a reminder for the particular person, or terminating the call without requiring input from the particular person after the call is answered.

The details are typically obtained by one or more of identifying the calling party's telephone number, identifying the calling party's location, identifying the calling party's name; voice recognition of the calling party; or call content based on a keyword, password or other call description. The determination of call forwarding is generally based on a comparison of the obtained details to information that is available to or knowledge of the artificial intelligence.

When the calling party is seeking to reach the particular person, the determination of call forwarding by the artificial intelligence is at least partially based on whether the particular person is available or not, wherein the call is not forwarded to the particular person by the artificial intelligence when the particular person is not available. The availability of the particular person may be determined by the artificial intelligence by a calendar; by a notification on the particular person's computer or telephone that is accessible by the artificial intelligence; by determining that the particular person is currently on a phone call, by determining that the particular person is in a location, e.g., as determined by GPS from the particular person's cell phone, or by determining that the particular person is historically unavailable at the time of the received call (e.g., when the person is not in the office, such as late at night), or by a notification to the artificial intelligence from the particular person. The notification to the artificial intelligence from the particular person is preferably through an app residing on the particular person's telephone or computer.

The method further comprises transcribing audio between the calling party and the artificial intelligence into text to assist in determining how the call is to be processed including whether the call should be forwarded to the particular person. The determination of call forwarding to the particular person when the particular person is available can also be based on detecting an elevated importance or urgency in the call from the calling party.

The detecting of the elevated importance or urgency is based on a keyword within the text which has been pre-designated as a keyword which indicates elevated importance or urgency. The detecting of elevated importance or urgency can also be based on voice or speech recognition which includes caller tone or speed of speech above a pre-defined threshold indicating the elevated importance or urgency or is detected by the artificial intelligence determining through semantic analysis that elevated importance or urgency exists.

When elevated importance or urgency is detected and the particular person is known to the artificial intelligence to be available, the artificial intelligence automatically forwards the call to the particular person, and when elevated importance or urgency is not detected, the artificial intelligence does not forward the call to the particular person, such as by taking a message or forwarding the call to voice mail.

The method can further comprise the artificial intelligence forwarding the intent to forward the call to a bidirectional transceiver associated with the particular person based on the detecting of elevated importance or urgency; and receiving data from the particular person indicating that the particular person is does not wish to receive the call; wherein the artificial intelligence then denies forwarding the call to the particular person. Alternatively, when the call is determined to be from an authorized calling party based on caller identification information, the call is forwarded to the particular person when the person is available. And when the call is determined to be from an unauthorized calling party based on a match of caller identification information, the artificial intelligence terminates the call, forwards the call to voice mail or takes a message. Authorized can refer to a calling party who is in the whitelist or some or all of the CallerID and ANI data of the calling party match to the information known to the AI. Authorized can refer to a calling party who is in the blacklist or some or all of the CallerID and ANI data of the calling party do not match to the information known to the AI.

The method also includes recording audio between the artificial intelligence and the calling party, or generating a transcript of the audio which is forwarded to the particular person for present or future action in deciding whether to answer or return the call or not or take other action. Another embodiment of the invention relates to a method of processing a telephone call from a calling party to a particular person in order to determine whether the call should be forwarded to the particular person. This method includes receiving a telephone phone call from the calling party that is directed towards a particular person; querying the calling party by artificial intelligence to obtain certain sufficient details of the call or calling party to enable the artificial intelligence to determine how to process the call, wherein the querying includes inquiries based on call content; and determining by the artificial intelligence whether the call should be forwarded to the particular person based on the obtained details of the call or calling party and call processing criteria associated with the artificial intelligence. As described herein, the artificial intelligence typically processes the call by forwarding the call to the particular person, taking a message from the calling party, directing the call to voice mail, directing the call to a third party, scheduling a meeting or callback on behalf of the particular person, receiving a reminder for the particular person, or terminating the call without requiring input from the particular person.

The querying by the artificial intelligence may include requesting identification information about the calling party, call content, or reason for the call. The determination of call forwarding can also be based on a comparison of the obtained details to information that is available to or knowledge of the artificial intelligence. The determination of call forwarding is at least partially based on whether the particular person is available or not, with the availability of the particular person determined by a calendar; by a notification on the particular person's computer or telephone that is accessible by the artificial intelligence; or by a notification to the artificial intelligence from the particular person. And the notification to the artificial intelligence from the particular person is preferably through an app residing on the particular person's telephone or computer. Thus, the method further comprises providing a transcript of communication between the calling party and the artificial intelligence to assist in determining whether the call should be forwarded to the particular person.

Yet another embodiment of the invention relates to a method of processing a telephone call from a calling party to a particular person in order to determine whether the call should be forwarded to the particular person. This method comprises receiving a telephone phone call from the calling party that is directed towards a particular person; obtaining certain details of the call or calling party by artificial intelligence; forwarding in real time the obtained details to the particular person; and determining by the artificial intelligence whether the call should be forwarded to the particular person based on the obtained details of the call or calling party and call processing criteria associated with the artificial intelligence. In this method, the particular person can override the determination made by the artificial intelligence based on a review of the obtained details that are provided in real time to the particular person.

This method further comprises providing to the particular person a transcript of communication between the calling party and the artificial intelligence. The obtained details are provided to the particular person by the artificial intelligence through an app residing on the particular person's telephone or computer. The details may also be obtained by identifying the calling party's telephone number, the calling party's location, the calling party's name; voice recognition of the calling party; or call content based on a keyword, password or other call description. The artificial intelligence may process the call by forwarding the call to the particular person, taking a message from the calling party, directing the call to voice mail, directs the call to a third party, scheduling a meeting or callback on behalf of the particular person, receiving a reminder for the particular person, or terminating the call without requiring input from the particular person.

The determination of call forwarding is generally based on a comparison of the obtained details to information that is available to or knowledge of the artificial intelligence. The artificial intelligence can be made aware of the availability of the particular person by the particular person's calendar; by a notification on the particular person's computer or telephone that is accessible by the artificial intelligence; by determining that the particular person is currently on a phone call, by determining that the particular person is in a location, as determined by the GPS coordinates of the person's cell phone, or by determining that the particular person is historically unavailable at the time of the received call, or by a notification to the artificial intelligence from the particular person of availability.

Another embodiment of the invention is a method of processing a telephone call from a calling party to a particular person in order to determine whether the call should be forwarded to the particular person. This method comprises receiving a telephone phone call from the calling party that is directed towards a particular person; obtaining certain details of the call or calling party by artificial intelligence; forwarding in real time the obtained details to a monitoring person; and determining by the artificial intelligence whether the call should be forwarded to the particular person based on the obtained details of the call or calling party and call processing criteria associated with the artificial intelligence. The monitoring person can assist the artificial intelligence in obtaining details or making the determination by communicating with the artificial intelligence so that the call is properly processed.

The method further comprises providing to the monitoring person a transcript of communication between the calling party and the artificial intelligence. In this regard, the transcript may be provided to the particular person by the artificial intelligence through an app residing on the particular person's telephone or computer and the person has the option to send a message to the artificial intelligence as to how to process the call in a manner different than that determined by the artificial intelligence. The details of the call may be obtained by identifying the calling party's telephone number, the calling party's location, the calling party's name; voice recognition of the calling party; or call content based on a keyword, password or other call description. And the determination of call forwarding is based on a comparison of the obtained details to information that is available to or knowledge of the artificial intelligence.

As noted herein, the artificial intelligence is generally aware of the availability of the particular person by the particular person's calendar; by a notification on the particular person's computer or telephone that is accessible by the artificial intelligence; or by a notification to the artificial intelligence from the particular person of availability.

The invention also relates to a network switch, comprising at least one phone network interface which receives phone calls at a first network node; a physical storage medium which stores audio from the phone calls; a speech recognition engine which transcribes at least some of the audio from the phone calls; a transcription engine which transcribes at least some of the audio from the phone calls; a packet-switched data network connection which transmits audio output of at least one of: text to speech synthesis; and pre-recorded audio to a calling party of the telephone call.

The audio output typically comprises responses based on output of the transcription engine; and while transcribing the at least some of the audio of the telephone call, the transcription is sent to a bidirectional transceiver at a second network node in real-time.

The audio output of the switch is based partially on artificial intelligence and partially on instructions received from the bidirectional transceiver receiving the transcription. The data I generally transmitted via the packet-switched data network to the bidirectional transceiver causing a plurality of selectable elements to be exhibited on the bidirectional transceiver, wherein the selectable elements are based on preceding conversation between the calling party and the artificial intelligence.

The selectable element of the selectable elements may be at least one selector which, when selected, causes the call to be forwarded to another network node or particular person. The selectable element of the selectable elements may also be at least one selector which, when selected, causes future calls from the calling party received at the first network node to be forwarded to the bidirectional transceiver, bypassing the step of the creating the transcription. Further, the selectable element of the selectable elements may be at least one selector, which, when selected, causes future calls from the calling party to carry out the step of the receiving the phone call at the first network node and the using speech recognition while skipping or suppressing the step of sending the transcription to the bidirectional transceiver. The preceding conversation can be detected as being related to scheduling a meeting between the calling party and another party, and the selectable elements comprise selections related to time.

The network switch also receives text input from the bidirectional transceiver via the packet-switched data network connection; and can play a speech synthesized version of the text input as part of the audio output. Audio input from the bidirectional transceiver may also be received via the packet-switched data network connection, with the audio input converted to text and a speech synthesized version of the audio input, based on the text, is exhibited over the phone network, such that the speech synthesized version matches a voice of the speech synthesis in the audio output.

The invention also relates to a telephone switch comprising at least one telephone network node and at least one network connection with a bidirectional transceiver, which receives a phone call at the at least one network node; uses speech recognition to create a transcription of audio of the telephone call; while creating the transcription of audio of the telephone call, sends the transcription to the bidirectional transceiver in real-time via the at least one network connection; and during the phone call, transmits audio output of at least one of text to speech synthesis and pre-recorded audio to a calling party via the at least one network node based on instructions received from the bidirectional transceiver.

The telephone switch can use speech recognition and a processor on the telephone switch to determine that the calling party wants to schedule a meeting, and the instructions received from the bidirectional transceiver include a date and time for the meeting. The instructions received from the bidirectional transceiver may indicate that a particular person is unavailable and a proposed time for the particular person to place a new telephone call to the calling party, the instructions further comprising the proposed new time.

The instructions can include playing audio in the telephone call based on input into the bidirectional transceiver. Also, the bidirectional transceiver, while receiving the transcription, may send instructions to the first network node to end the telephone call; and the telephone call is disconnected from the first network node. Alternatively, the bidirectional transceiver, while receiving the transcription, may send instructions to the first network node to forward the phone call to a third party. During the phone call, audio is transmitted to the calling party indicating the phone call is being transferred or answered; and the telephone call is then forwarded from the first network node to a bidirectional transceiver associated with the third party.

Another embodiment of the invention relates to a method of conditionally forwarding a received phone call to a bidirectional transceiver associated with a particular person, comprising the steps of receiving the phone call at a network node, the phone call directed towards a particular person, and determining an identity of a calling party based on at least one of call identification information, voice recognition, and speech recognition: determining that the particular person is unavailable: detecting urgency in a voice of the calling party based on content, as determined by speech recognition, of the phone call originating from the calling party.

The method may include an additional step of forwarding the call to the bidirectional transceiver associated with the particular person based on the detecting of urgency. The method may also include a step of transcribing into text the audio within the phone call originating from the calling party, with the step of detecting urgency being based on a keyword within the text which has been pre-designated as a keyword which indicates the urgency. This can also indicate an elevated importance of the call as well.

The step of detecting urgency is further based on a combination of tone and speed of speech above a pre-defined threshold indicating the urgency. The urgency may be detected in the voice of the calling party and the call; a request from the calling party for the call to be sent to the calling party is denied based on the call identification information matching pre-designated call identification information.

The method can include an additional step of forwarding the call to the bidirectional transceiver associated with the particular person based on the detecting of urgency is carried out at least a first time; and receiving data from the particular person indicating that when the particular person is unavailable calls from the calling party with the urgency in the voice, and denying forwarding of a subsequent call from the calling party to the particular person when the particular person is unavailable. When the subsequent call is determined to be from the calling party based on a match of voice recognition in the subsequent call and the call, the call is forwarded to the bidirectional transceiver associated with the particular person. When the subsequent call is determined to be from the calling party, based on a match of caller identification information in the subsequent call and the call, the call is also forwarded to the bidirectional transceiver associated with the particular person.

The method may also include a step of transcribing into text the audio within the phone call originating from the calling party when urgency is detected in the voice of the calling party and the call; and a request from the calling party for the call to be sent to the calling party is denied based on a detected keyword in the text transcribed from audio of the calling party.

Alternatively, the method may include an additional step of forwarding the call to the bidirectional transceiver associated with the particular person, based on the detecting of urgency; receiving data from the particular person indicating that the forwarding of the call was desired or undesired; and forwarding, or denying forwarding of a second call from a second calling party based upon aspects of the second call which correspond to a first the call which was forwarded to the bidirectional transceiver associated with the particular person.

The comparable aspects may include grammar and syntax, as determined by using speech recognition and transcription of the first call and the second call. The comparable aspects may instead be keywords in the call, as determined by using speech recognition and transcription of the first call and the second call. The comparable aspects may also be location proximity, as determined based on the call identification information of the first call and the second call. The call identification information can also be selected from the group consisting of callerID and ANI and comprises a further lookup in a database to determine a location of the calling party based on the callerID or ANI information. The comparable aspects can also be a location, as determined based on prompting each the calling party for same during each the phone call, and comparing a distance of each the location to each other. Other comparable aspects are speaking tone and speaking speed, or tonal changes, as determined by using speech recognition such as between a first and second time period during each respective the first call and the second call. The comparable aspects may also be the sex of respective calling parties, as determined by using speech recognition for the first call and the second call. The step of detecting urgency may further be based on grammar and syntax of a transcription of the content of the phone call. And additionally, the comparable aspects may be time periods between the respective calls.

After the step of determining that the particular person is unavailable, the artificial intelligence can indicate the same to a calling party via audio within the phone call.

Yet another embodiment of the invention is a method of receiving a telephone call, comprising the steps of receiving a phone call at a first network node; using speech recognition, creating a transcription of audio of the telephone call; while creating the transcription of audio of the telephone call, sending the transcription to a bidirectional transceiver at a second network node in real-time; receiving instructions from the bidirectional transceiver to send the telephone call to the second network node; and sending the call to the second network node.

After receiving the phone call at the first network node, the artificial intelligence may have a conversation with a calling party of the telephone call using text to speech synthesis and text of the text to speech synthesis is used in the transcription of the call. After receiving the phone call at the first network node, it is also possible for the artificial intelligence to have a conversation with a calling party of the telephone call using pre-recorded audio; and generate a transcript of the pre-recorded audio which is stored before the telephone call is made and used in the transcription. This allows the audio of the telephone call to be played at the bidirectional transceiver in real-time, before the step of receiving instructions from the bidirectional transceiver to send the telephone call to the second network node. In some embodiments, the transcription of audio may continue after the phone call is sent to the second network node, and the audio of the phone call may also be sent to a third network node while the call is sent to the second network node.

Another embodiment relates to a method of receiving a telephone call, comprising the steps of receiving a phone call at a first network node; using speech recognition, creating a transcription of audio of the telephone call; while creating the transcription of audio of the telephone call, sending the transcription to a bidirectional transceiver at a second network node in real-time; and during the phone call, transmitting audio output of at least one of text to speech synthesis and pre-recorded audio to a calling party, based on instructions received from the bidirectional transceiver receiving the transcription.

In this method, the speech recognition can determines whether the calling party wants to schedule a meeting, and the instructions received from the bidirectional transceiver can then include a date and time for the meeting. The instructions received from the bidirectional transceiver can also indicate whether a particular person is unavailable, and can provide a proposed time for the particular person to place a new telephone call to the calling party, the instructions further comprising the proposed new time.

The instructions can include playing audio during the telephone call, based on input into the bidirectional transceiver, while the artificial intelligence sends instructions to the first network node to end the telephone call; and then disconnects the telephone call from the first network node. The bidirectional transceiver, when receiving the transcription, can send instructions to the first network node to forward the phone call to a third party; while during the phone call, audio mat be is transmitted to the calling party, indicating the phone call is being transferred or answered; and the telephone call is then forwarded from the first network node to a bidirectional transceiver associated with the third party. The method can also include when creating the transcription, detecting urgency by a device at the first network node, so that the telephone call is forwarded from the first network node to the bidirectional transceiver.

The invention also relates to a method of communicating with a caller using artificial intelligence when receiving a telephone call, comprising the steps of receiving a phone call at a first network node; based on speech recognition of audio received from the calling party, creating a transcription of the audio received from the calling party; transmitting audio output of at least one of: text to speech synthesis; and pre-recorded audio to a calling party of the telephone call. The audio output typically includes responses based on the speech recognition; and while creating the transcription of at least some of the audio of the telephone call, the transcription is sent to a bidirectional transceiver at a second network node in real-time.

The audio output may be based partially on artificial intelligence and partially on instructions received from the bidirectional transceiver receiving the transcription. The method may also include a step of sending data to the bidirectional transceiver sufficient to cause a plurality of selectable elements to be exhibited on the bidirectional transceiver, wherein the selectable elements are based on preceding conversations between the calling party and the artificial intelligence.

A selectable element of the selectable elements generally comprises at least one selector which, when selected, causes the call to be forwarded to another network node or particular person. The selectable element of the selectable elements may also comprises at least one selector, which, when selected, causes future calls from the calling party received at the first network node, to be forwarded to the bidirectional transceiver, bypassing the step of the creating the transcription. And a selectable element of the selectable elements may also be at least one selector, which, when selected causes future calls from the calling party to carry out the step of the receiving the phone call at the first network node and the using speech recognition while skipping or suppressing the step of sending the transcription to the bidirectional transceiver.

When preceding conversation is detected as being related to scheduling a meeting between the calling party and another party, and the selectable elements comprise selections related to time. The method can also include a step of receiving text input from the bidirectional transceiver; and playing a speech synthesized version of the text input as part of the audio output. The method can also include the step of receiving audio input from the bidirectional transceiver; converting the audio input to text; and playing a speech synthesized version of the audio input, based on the text, such that the speech synthesized version matches a voice of the speech synthesis in the audio output. Another additional step of the method may include repeating the step of transmitting audio output of the speech synthesis comprising the responses based on the speech recognition, after the step of playing the speech synthesized version of the audio input. The transcription further comprises a transcription of the text which is part of the transmitting of the audio output.

Any device or step to a method described in this disclosure can comprise, or consist of, that which it is a part of, or the parts which make up the device or step. The term “and/or” is inclusive of the items which it joins linguistically and each item by itself. The term “substantially” can be used to modify any other term in this disclosure and defined as “at least 90% of” or “within half a second of” the term being modified.

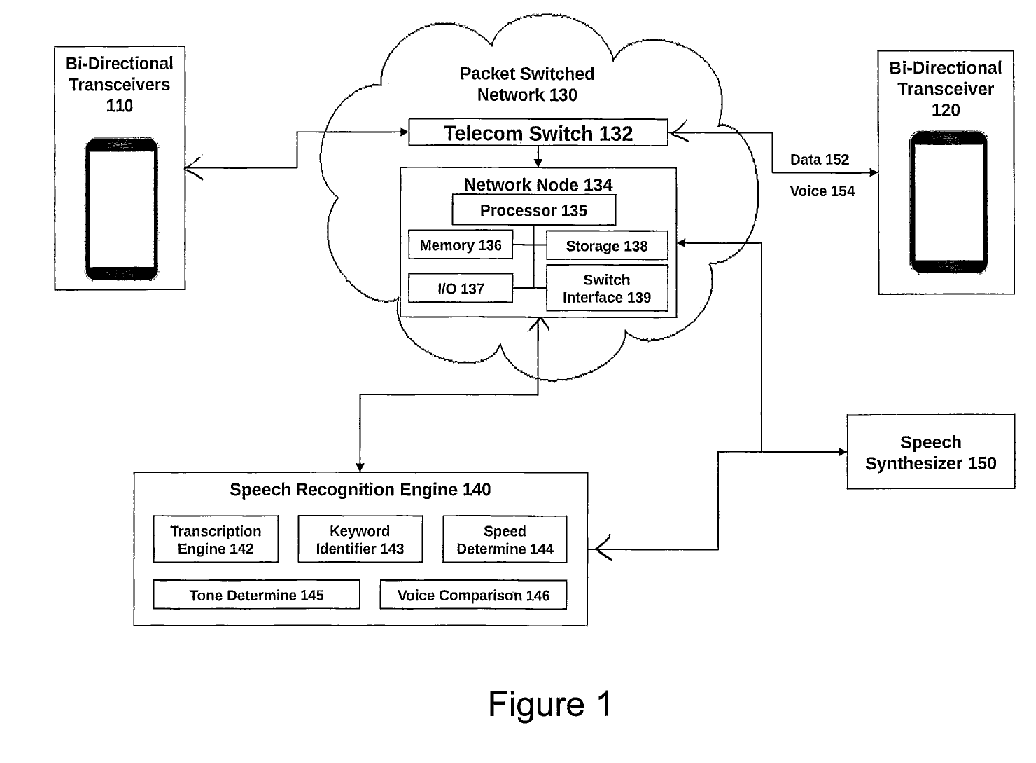

Turning now to the drawing figures, FIG. 1 is a high level block diagram of devices which are used to carry out embodiments of the disclosed technology. A bi-directional transceiver 110 associated with a calling party is shown. Typically, a call is placed from one calling party 110, with an intent to reach an entity associated with a receiving device, such as a bi-directional transceiver 120, which is the called party. This call can be over a regular phone line or phone network and have aspects or parts of the call which are wired or wireless. The called party can be a particular person operating the device 120 (such as an individual whose identity, e.g., name, is known prior to placing the call and/or the individual to whom the telephone number of the device 120 is assigned to) or any one of a group of people (such as an employee of a company who is randomly assigned by the company to answer the call). In some embodiments of the disclosed technology, the called party is any live human being who is conversing via the telecommunications switch 132, and the network node 134 is any non-live person or synthesized speech from text (e.g., “artificial intelligence”) doing likewise. One or more of the bi-directional transceivers can have some or all of the following elements: a GPS (Global Positioning System) receiver, an accelerometer, input/output mechanisms, and a transmitter.

Calling party identification mechanisms used to determine who the calling party is, include location determination mechanisms based on location reported by the GPS, the Internet protocol (IP address) of one of the bi-directional transceivers 110 and/or 120, and looking up a location associated with a number reported by the calling line identification (caller ID) or ANI (automated number identification) protocols.

Input/output mechanisms of the bi-directional transceivers can include a keyboard, touch screen, display, and the like, used to receive input from, and send output to, a user of the device. A transmitter enables wireless transmission and receipt of data via a packet-switched network, such as packet-switched network 130. This network, in embodiments, interfaces with a telecommunications switch 132 which routes phone calls and data between two of the bi-directional transceivers 110 and 120. Versions of these data, which include portions thereof, can be transmitted between the devices. A “version” of data is that which has some of the identifying or salient information, as understood by a device receiving the information. For example, audio converted into packetized data can be compressed, uncompressed, and compressed again, forming another version. Such versions of data are within the scope of the claimed technology, when audio or other aspects are mentioned.

Referring again to the telecom switch 132, a device and node where data are received and transmitted to another device via electronic or wireless transmission, it is connected to a network node 134, such as operated by an entity controlling the methods of use of the technology disclosed herein. This network node is a distinct device on the telephone network, which sends and receives data to the telephone network, or another network which carries audio or versions of data used for creating, or were created from, audio. At the network node is a processor 135 deciding when the bi-directional transceivers 110 and 120 can communicate with each other via audio, such as by forwarding the call from a transceiver 110 to a transceiver 120. At the network node 134 there is also memory 136 (volatile or non-volatile) for temporary storage of data, storage 138 for permanent storage of data, and input/output 137 (like the input/output 124), and an interface 139 for connecting via electrical connection to other devices.

Still discussing FIG. 1, a voice or speech recognition engine 140 is used. This is a device which receives audio input, detects speech and can do any one or a multiple of things with speech, such as transcribing the speech into text with a transcription engine 142, identifying keywords in the text with a keyword identifier 143, determining the speed of the speech (144) over the course of the audio, determining the tone of the audio (145), and determining whose voice the audio belongs to by comparing the voice to previous calls (146). In this manner, aspects of the audio and, therefore, aspects of the call, are determined. Based on this, a speech synthesizer 150 is used, in embodiments of the disclosed technology, to communicate back over an audio channel (such as on a phone call) with the caller via the network node 134. In other embodiments, recorded voices can be used instead of, or in conjunction with, the synthesized speech.

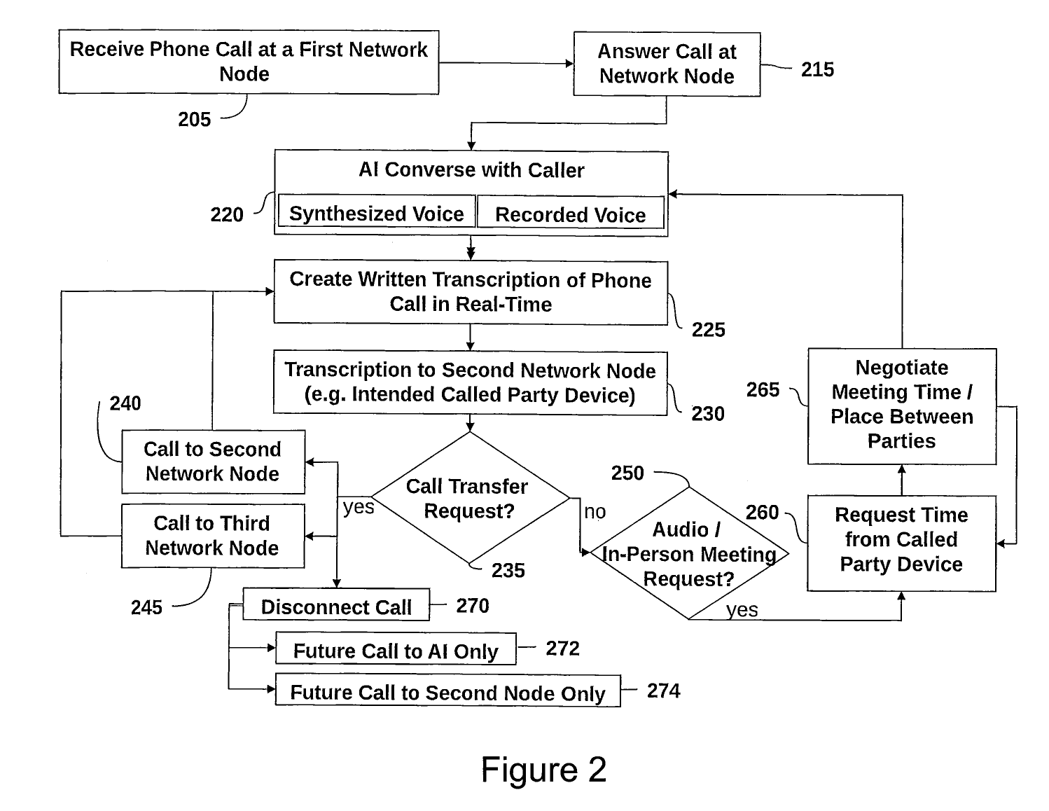

FIG. 2 is a high level flow chart depicting how calls are answered, transcribed, and manipulated, in embodiments of the disclosed technology. In step 205, a phone call is received at a network node designated for a called party or intended/actual recipient person or entity for the call. The definitions and descriptions of who the called party can be are described with reference to FIG. 1. Preferably, the called party is a particular person operating the device 120 (such as an individual whose identity, e.g., name, is known prior to placing the call and/or an individual who owns the device 120), but the invention is operable to handle incoming calls to a particular business or phone number even when the caller does not know who might answer o who they may be transferred to during the call.

The call is answered in step 215 and an AI (artificial intelligence) begins to converse with the caller in step 220, using either a synthesized voice (text to speech) or recorded voice, as appropriate or designated ahead of time. A called party may elect to have all calls answered by an artificial intelligence system, indicate a time of day and/week when calls are answered by the AI, or only have this happen when the called party is unavailable. In order to do this, a plethora of factors can be taken into account. Before or after answering the call, callerID or ANI data is checked. This may, in step 220, help to determine the location of the calling party, which can be a factor in forwarding the call. For example, international calls can be sent to the called party even when he/she is “unavailable”. Or the data can match a person on a “whitelist” and thus be forwarded to the called party. A calling party can be whitelisted, as will be described in step 274. In some embodiments, an indication is made to the calling party, during step 220, that the called party is unavailable. In other embodiments, the calling party does not receive an indication as such, but in any case, the method proceeds with step 220, where a synthesized or recorded voice is used to converse with the calling party.

While the call is taking place between the called party and the AI in step 220, a written transcription of the call can be created in real-time in step 225, based on the text (converted to speech), text transcribed of the recorded voice, and/or the voice of the calling party converted to text. This transcription, again, in real-time or at the same moment in time that another part of the conversation is being transcribed, is sent to a second network node, such as bi-directional transceiver 120. Thus, the calling party (such as party 110) and the AI are having a conversation with audio back and forth, speech to text, and text to speech, while the called party and/or second network node and/or bi-directional transceiver 120 is receiving a written transcribed version of part or all of the audio between the calling party and AI.

A sample transcription of the audio in the phone call between the AI and the calling party might look something like this, by way of example:
Synthesized voice: “I'm sorry, but Mr. Lippman is unavailable. Is this an urgent matter?”
Calling Party: “Yes, it is!”
Synthesized voice: “Please tell me why it's urgent.”
Calling Party: “I can't find the cat food, and the cat needs to eat!”
Synthesized voice: “Who is this, by the way?”
Calling Party: “It's Mr. Lippman's son.”
Synthesized voice: “Okay, let me see if Mr. Lippman is available to answer the call.”

The calling party and urgency of the call can be determined automatically based on the text transcription of the conversation. For example, Mr. Lippman's son might be determined as being the caller based on voice recognition (comparing the voice to previous calls with “son”), his location (comparing to prior locations when the son called and/or limiting the location when it is believed to be the son to calls from a certain area code or area codes that Mr. Lippman has previously designated as where his “family” might be calling from), or the like. In this case, urgency might also be detected based on certain keywords such as “son” or “cat.” Mr. Lippman might want all calls from his son to be detected as urgent, so that the call might be detected as “urgent” as soon as the calling party says “Yes, it is!” or makes another recognizable utterance determined to be from a specific calling party.

Or, in another embodiment, a negative keyword such as “cat” may be used. Thus, if someone says “cat,” the call will be considered non-urgent because Mr. Lippman doesn't want to be interrupted to talk about the cat when he is unavailable. In any of the above cases, once urgency is detected, the call can be sent to the called party in step 240, such as to a device associated with the called party or under the direct operative control of the called party, such that, the called party can exchange audio with the calling party in the phone call.

In other embodiments, the called party and/or second network node and/or bi-directional transceiver 120 sends data, which are received by a device carrying out parts of the disclosed technology such as a telephone switch (which can comprise a single physical device or many such devices interacting directly or indirectly with the telephone network effecting audio in the telephone network itself). These data can include, as in step 235, a request to transfer the call to another party. That is, the call can be transferred to the second network node in step 240, or a third network node in step 245. The “third network node” can be, in embodiments of the disclosed technology, a third location or third party previously unconnected to the audio or transcript of the call taking place. The location can be any location authorized by the called party to receive the transferred call such as home, office, or call center. The third party can be an individual (e.g., the called party's family member or secretary) or entity (e.g., call center's representative) who is authorized by the called party to take the call. This can be a form of call forwarding which involves forwarding the call itself to another telephone network node and/or forwarding the real-time or live transcription to another.

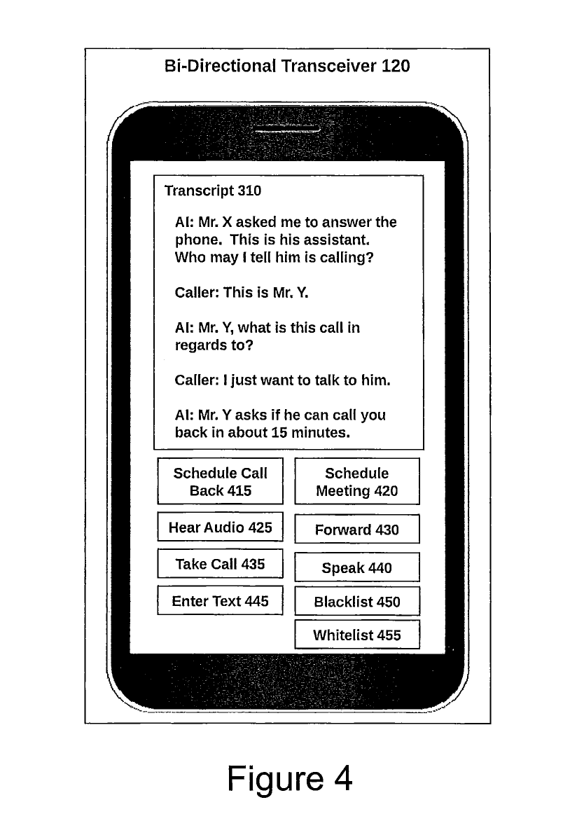

Or, in step 270, the bi-directional transceiver 120 can send instructions for the call to be disconnected. This can take place instead of, or after, steps 240 and/or 245. This can be indicated by hanging up the phone or selecting a button exhibited on the phone to disconnect the call. Further, once the call is disconnected, or as a function of selecting to disconnect the call (via voice instruction or text instruction which is recognized as such, or selecting a button, such as shown in FIG. 4 on a bi-directional transceiver), then future calls recognized as coming from the particular calling party can be send to the AI only in step 272 (bypassing steps of providing the transcription to the bi-directional transceiver in real-time), or directly to the bi-directional transceiver in step 274 (bypassing steps of providing an AI conversation with the caller after determining that the calling party has been whitelisted). Thus, in the case of a blacklist or whitelist (such as by carrying out steps 272 and 274, respectively) then future calls received in step 205 are handled accordingly. Whitelisted calls skip at least step 220 and can skip one or more additional steps described herein. Blacklisted calls skip step 230 and can skip one or more additional steps described herein. Until a call is determined to be from a calling party who is whitelisted, all the steps (e.g., step 230) can be carried out, and the transfer to the second network node in step 240 is carried out upon determining that it is a whitelisted caller. A whitelisted caller might have a password to pronounce or enter (via DTMF tones).

If no call transfer request is made in step 235, then step 250 can be carried out. Otherwise, the AI can continue to converse with the caller while steps 220, 225, and 230 are carried out cyclically and/or simultaneously until the calling party or AI decides to end the call and disconnect the phone call. Though, if step 250 is answered in the affirmative and meeting time is requested, then steps 260 and 265 are carried out cyclically, where in step 260, a requested time is presented to the called party, and in step 265 a meeting time and place is negotiated. The meeting time and place can be arranged entirely by the calling party and artificial intelligence, and in some embodiments, also with the input, during the call, into the bidirectional transceiver receiving the transcription. The negotiation process can be performed with or without the calling party knowing that the called party is providing input. This meeting time and place can be a physical meeting place, or simply a time when the calling party and an intended recipient or other human being, such as an operator of the bidirectional transceiver (120) at the second network node, can converse via voice. Such a negotiated time for a further phone call might create a temporary whitelist for the calling party at the time of the future call, or provide a password/passcode for the calling party to present for the subsequent call to reach the bidirectional transceiver by way of carrying out step 240. After negotiating the time and place, the call can continue between the calling party and AI (steps 220, 225, and, in some cases, step 230).

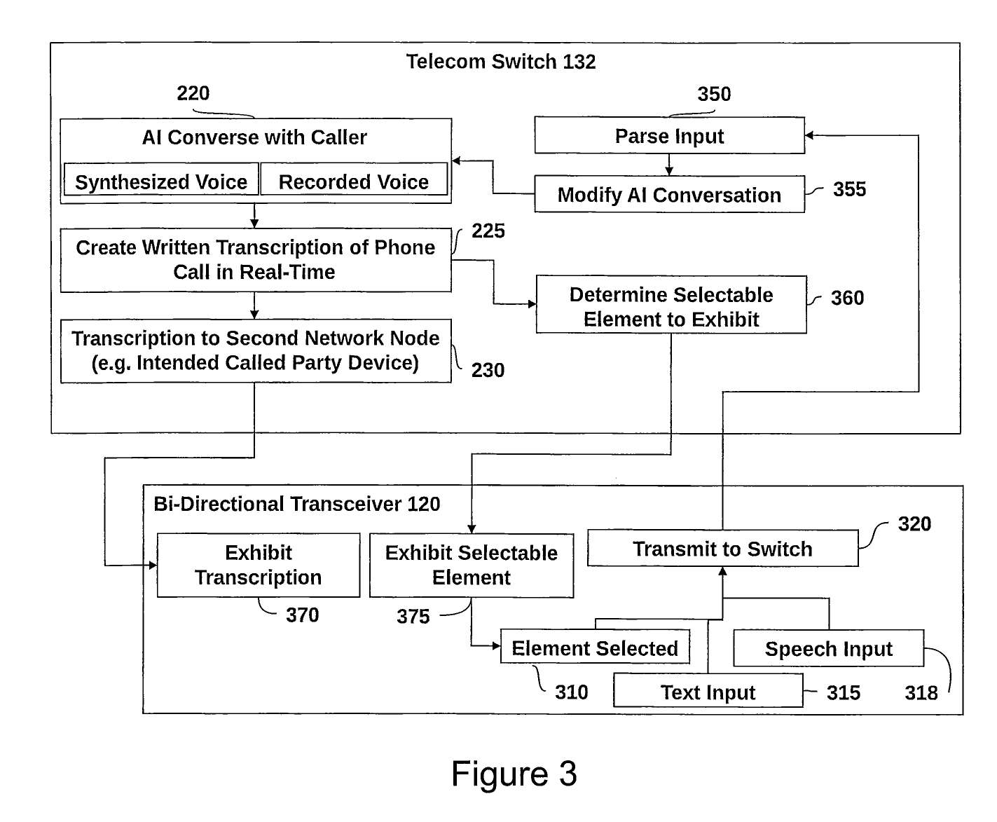

FIG. 3 is a high level flow chart of interactions between a telecommunications switch and a bi-directional transceiver, in embodiments of the disclosed technology. Here, steps carried out by the telecommunication switch 132 are shown in the upper block, while steps carried out at the bi-directional transceiver 120 are shown in the lower block. As described above, the telecommunications switch 132 is a device, or plurality of devices, which work in concert or based on instructions from one another to carry out the methods claimed in embodiments of the disclosed technology, including but not limited to, communication with a phone network.

Steps 220, 225, and 230 remain as shown and described with respect to FIG. 2. Once a transcription is sent to the second network node in step 230, it is displayed on a device at such a second network node, in this case, the bi-directional transceiver 120. This transcription is exhibited at this device in step 370 and is in real-time, or substantially real-time, to the conversation taking place in, at least, step 220. Further, during the course of the conversation between the AI and the calling party, queries may be sent to be displayed on the bi-directional transceiver. For example, in the description of FIG. 2, it was explained how scheduling a meeting takes place in embodiments of the disclosed technology. Proposed times for the meeting, by way of example, can be made by the calling party or AI and determined to be selectable elements to exhibit in step 360. A selectable element might also include selection to drop the call, forward the call, or the like, as will be described further with reference to FIG. 4. Thus, in step 375, such selectable elements are exhibited, e.g., a button displayed on the screen of the bi-directional transceiver 120.

In addition to selecting an exhibited selectable element in step 310, a person operating the bi-directional transceiver 120 might also input text or speech in response to a query made by the AI to the second party (person receiving the transcript). A conversation, for example, might take place as follows:
Calling Party: “Please tell Adam his refrigerator is running.”
AI: “I can do that for you. Hold on one moment.”

Adam, viewing this conversation, might read this in the transcription on his device and then select a button such as, “Acknowledge receipt” in step 310, enter text into his device (e.g., by typing or selecting letters) in step 315, such as “I know” or inputting speech into a microphone of the device in step 318 by saying, “I know.” In any of these cases, the inputted information on the bi-directional transceiver is then transmitted to the switch in step 320, such as via a wired or wireless network, such as a cellular phone data network or wired IP connection.

In another example, the calling party and AI are having a back and forth conversation such as follows:
Calling Party: “My internet is down.”
AI: “I understand your internet connection is not working. Did you check if your router is plugged in?”
Calling Party: “The problem is DNS server is not responding.”
AI: “Again, did you unplug your router and plug it back in?”
Calling Party: “Ugh. Don't you understand what I'm saying?”

At this point, the person reading the transcript over at the bi-directional transceiver may carry out step 315 or 318 and free-form enter text to be inserted into the conversation such as, “What is your DNS server IP address currently?” The AI will wait for a moment in the conversation to enter the text in step 350, when the input is parsed, and then modify the AI conversation in step 355 accordingly. The AI can transcribe the speech input 318 into text or use the text in step 315 and transcribe this into the AI voice stating, “What is your DNS server IP address currently?” In this manner, the calling party is still hearing only the AI but the input for the conversation is actually from a human interacting directly with the conversation.

In yet another embodiment, an AI need not be used at all. Building on the tech support example above, suppose the AI which does not understand “DNS server” is actually a human being. In such a case, in step 220 a human is conversing with the caller. In this case, the written transcript in step 225 is still carried out based on, at least in part, instructions read by the tech support person or speech recognition. The modification of the AI conversation in step 355 then becomes modification of the conversation, based on input provided by the second party. So the second party might then tell the tech support person (the called party) what to say, while monitoring the transcript. Many such transcripts of many simultaneous calls can be monitored in this way by, for example, a person with more experience in handling calls. Upon seeing that a call needs to be escalated to a higher level, such a selectable element can be selected in step 310, transmitted to the switch in 320, and the call is forwarded to the second party or another party better able to handle the call.

FIG. 4 depicts a bi-directional transceiver of a second party with real-time transcription and selectable elements used to interact with a calling party, in embodiments of the disclosed technology. Here, an example of a transcript 310 is shown above a variety of selectable buttons or elements numbered in the 400s. In this example, the AI and caller converse (again, AI can be replaced with a live human attendant, in embodiments of the disclosed technology), and the transcript is sent to the bi-directional transceiver 120, where it can be monitored in real-time. The selectable elements 400s can be specific selectable elements based on the conversation or general selectable elements that apply to all the conversations. Any one or a plurality of the selectable elements can be shown before the conversation or at any given time during the conversation. Moreover, one or more of the selectable elements can be shown before the conversation and additional selectable elements can be subsequently shown at any given time during the conversation. Any of these selectable elements can change as the conversation or the transcription progresses.

Selectable element 415 instructs the AI to schedule a time to call back later and determine who will make the call (the calling party or the called party) and to what number. This is confirmed through a conversation where such information is exchanged and confirmed between the calling party (shown as “caller” in the figure) and the AI. Similarly, using selectable element 420, an in-person meeting can be scheduled. The operator of the device 120 may also desire to hear the audio in real-time by using selectable element 425 to do so. While doing so, the rest of the selectable elements can continue to function as before. Or, the person can take the call outright, using button 435, and the call is forwarded to the bi-directional transceiver 120. In some embodiments, the transcription continues, while in others the transcription ceases at this point.

The person can also select “forward” button 430 to have the call forwarded to a third party, as described with reference to FIG. 3. In such a case, the AI may first announce what is happening and to whom the call is being forwarded, either immediately or as part of a give and take (flow) of the conversation, waiting for an appropriate moment (pause) in the conversation. This is true of any interjection into the conversation by the second party including while using buttons 440, 445, 415, and 420. Buttons 440 and 445 are related, in that they allow the second party to interject into the call by either speaking (440) or entering text (445) which, as described with reference to FIG. 3, is parsed and inputted into the conversation with the calling party. After such an interjection by the second party, this party may decide to have the AI carry on the conversation based on the interjection and trajectory of the conversation at this point, or may choose to take over all further communication by communicating in such a manner, using selectable elements and/or speaking and/or entering text.

The blacklist selectable element 450 ensures that next time a particular calling party is recognized (such as by using voice recognition or caller identify information [e.g. CallerID or AM]) the steps of sending a transcript to the second party/second node/bi-directional transceiver 120 are not carried out. Conversely, the whitelist selectable element 455 ensures that the next time a particular calling party is recognized in a subsequent call, the call is forwarded with two-way voice communication to the second node/bi-directional transceiver 120. In such a case, a transcription may or may not be made, depending on the embodiment. Thus, it should also be understood that hearing audio 425 and speaking 440 involves one way audio communication, whereas taking a call 435, or forwarding a call 430, involves two way audio communication. Speaking 440 can actually involve no direct audio communication, as a version of the spoken word is sent based on speech to text (speech recognition), followed by text to speech conversation, so that the speech is in the voice of the AI or other called party handing the audio of the call.

Some of the embodiments of the disclosed technology are related to call forwarding to unavailable party based on artificial intelligence. A called party indicates that he or she is unavailable to receive a call. However, by way of a combination or any one of determining aspects of who the caller is, where the caller is located, what he is speaking about, or the like, as well as comparing this to prior calls, an alert might be sent to a called party to join in the call. This can be by way of speech recognition of the caller and creating a transcript, and by receiving feedback from a called party about prior calls.

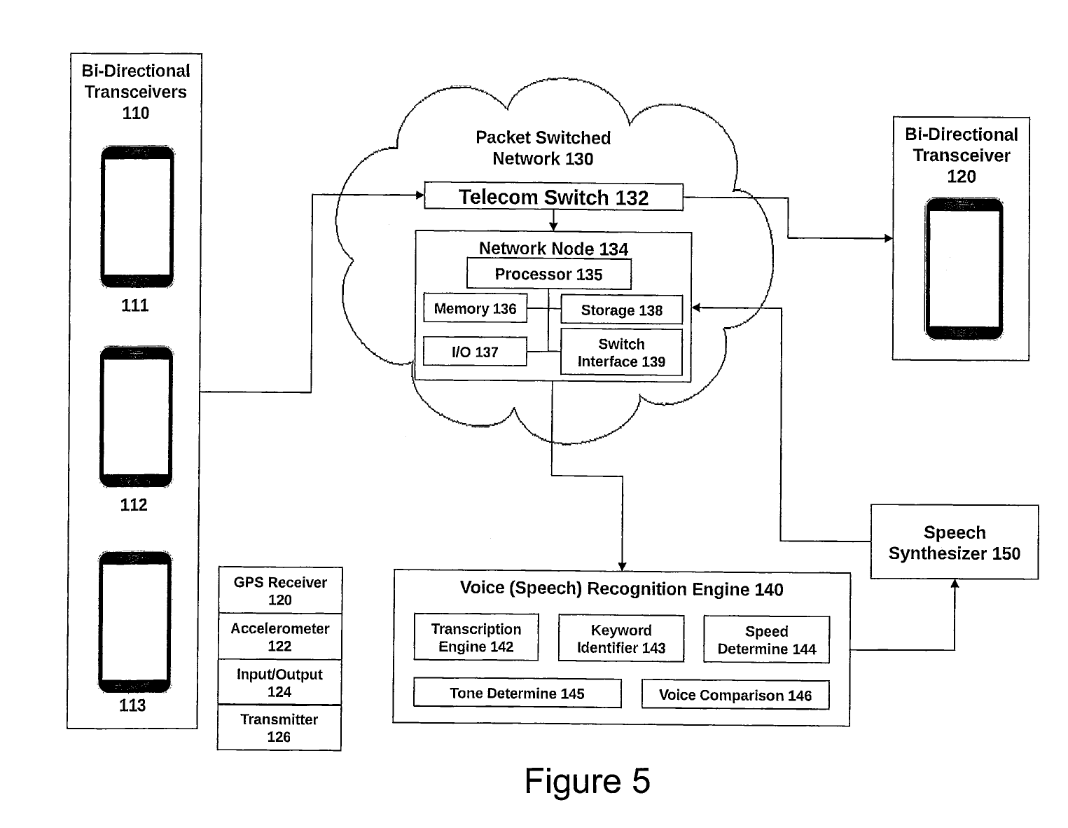

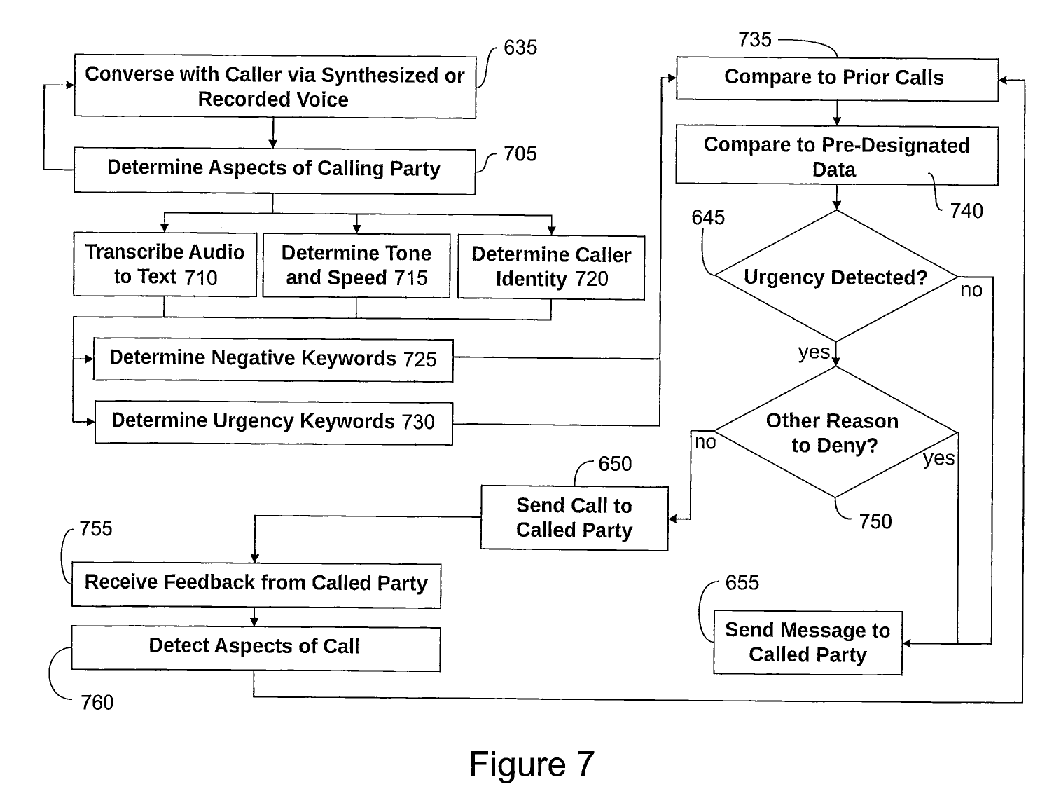

FIG. 5 is a high level block diagram of devices which are used to carry out embodiments of the disclosed technology. A plurality of bidirectional transceivers 510 associated with calling parties is shown. Typically, a call is placed from one calling party 110 (represented by one of the phones 111, 112, or 113), with an intent to reach an entity associated with a receiving device, such as a bidirectional transceiver 120, which is the called party. The reason for showing multiple calling parties will become apparent when discussing FIG. 7, below, where aspects of prior calls are compared to determine if a call should be considered urgent and/or forwarded to the called party. This call/these calls can be over a regular phone line or phone network and have aspects or parts of the call which are wired or wireless. The called party can be a particular person operating the device 120 or any one of a group of people, such as an employee of a company being called by a calling party 110. In some embodiments of the disclosed technology, the called party is any live human being who is conversing via the telecommunications switch 132, and the network node 134 is any non-live person or synthesized speech from text (e.g., “artificial intelligence”) doing likewise. One or more of the bidirectional transceivers can have some or all of the following elements: a GPS (Global Positioning System) receiver 120, an accelerometer 122, input/output mechanisms 124, and a transmitter 126.

All the devices shown in FIG. 5 and their functions are similar to those described with respect to FIG. 1. As such, all the disclosure on FIG. 1 are equally applicable to FIG. 5 and will not be repeated here.

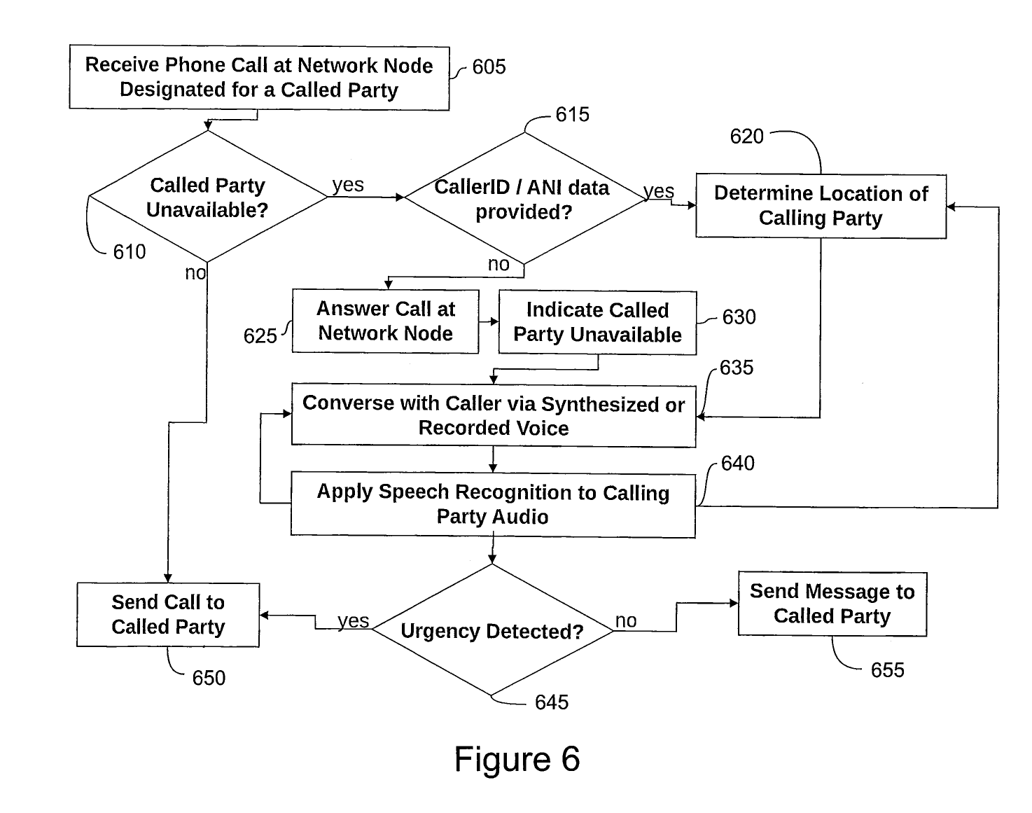

FIG. 6 is a high level flow chart depicting how calls are forwarded to a called party when they are urgent, in embodiments of the disclosed technology. In step 605, a phone call is received at a network node designated for a called party. The definitions and descriptions of who the called party can be are described with reference to FIG. 1. A determination is then made, in step 610, if the called party is unavailable. See the definition of “unavailable” in the summary of the disclosed technology. Further, unavailable status can be determined by receiving an indication of same from a called party (such as by way of his/her receiver 620), by his/her not answering a phone call, by GPS reporting on his/her device that the device is at a location or outside of a geo-fenced area where he/she becomes unavailable, and the like. For example, the called party may only be available when at work, but when going home and leaving proximity to work, he/she may want to be “unavailable” to regular calls.

If the called party is available, the call is simply sent to the called party in step 650, by way of his/her device (e.g., his/her phone or bidirectional transceiver 610). If not, then it must be determined if the call should be sent to the called party anyway. In order to do this, a plethora of factors can be taken into account. That is, any one, a combination of, or plurality of the factors and concepts discussed in the summary, and from this point through the rest of the “detailed description” can be used to send a call to a called party who is unavailable. Before or after answering the call, callerID or ANI data is checked. This may, in step 620, help determine the location of the calling party, which can be a factor in forwarding the call. For example, international calls can be sent to the called party even when he/she is “unavailable.” Or the data can match a person on a “whitelist” and thus be forwarded to the called party. Before or after this determination, the call is answered at a network node, in step 625. In some embodiments, an indication is made to the calling party (in step 630) that the called party is unavailable. In other embodiments, the calling party does not receive an indication as such, but in any case, the method proceeds with step 635, where a synthesized or recorded voice is used to converse with the calling party. Speech recognition is applied, in step 640, to determine what is being said and transmitting in the call by the calling party.

In step 645, a conversation might take place to determine if the call is urgent. So describing steps 635, 640, and 645 a conversation via a synthesized voice (text to speech) or recorded voice, played at the appropriate time during the call, might look something like this:
Synthesized voice: “I'm sorry, but Mr. Lippman is unavailable. Is this an urgent matter?”
Calling Party: “Yes, it is!”
Synthesized voice: “Please tell me why it's urgent.”
Calling Party: “This is Mr. Lippman's wife: our son was just in a car accident and is in the hospital.”
Synthesized voice: “I will connect you with Mr. Lippman.”

During this conversation, or in other embodiments, before or after the conversation with the synthesized or recorded voice, step 620 can be carried out to determine the location of the calling party, as described above. Thus, Mr. Lippman's wife might be determined as being the caller based on voice recognition (comparing the voice to previous calls with his wife, her location (comparing to prior locations when the wife called and/or limiting the location when it is believed to be the wife calling from a certain area code or area codes that Mr. Lippman has previously designated as where his “family” might be calling from), or the like. In this case, urgency might also be detected based on certain keywords such as “son” or “hospital.” Mr. Lippman might want all calls from his wife or son to be detected as urgent, so that the call might be detected as “urgent” as soon as the calling party says “Yes, it is!” or makes another recognizable utterance determined to be from a specific calling party by voice recognition.

In any of the above cases, once urgency is detected in step 645, the call is sent to the called party in step 650, such as to a device associated with the called party or under the direct operative control of the called party, such that, the called party can exchange audio with the calling party in the phone call. If urgency is not detected, the call is not forwarded to the called party. The called party may be sent a message in step 655. This message can be during the phone call or after the phone call, and in the form of a text or voice message having a version of the audio from a portion of the call.

FIG. 7 is a high level flow chart which depicts further aspects of determining urgency, in embodiments of the disclosed technology. Here, steps numbered in the 600s are the same as the steps shown and described with respect to FIG. 6. Thus, in step 635, the caller converses with the synthesized or recorded voice. While this step takes place, aspects of the calling party are determined in step 705 in a continuous loop, in embodiments of the disclosed technology. These aspects include one or a combination of the following. One such aspect is the grammar and/or syntax of the calling party. Does the syntax indicate correctly spoken English (or another language)? Does the syntax indicate a person from a certain geographic area? Other aspects of grammar and syntax detection can include a type of grammar or syntax used by those in urgent situations, such as louder voices, shorter sentences, or an otherwise excited state of speech which is detected. Syntax comprising or consisting of semantic content which denotes an emergency is also considered. Other aspects can be based on questions such as does the syntax match that of a prior caller? Was this prior caller, who was forwarded to the called party, wanted by the called party, or did the called party indicate that the call should not have been forwarded. This is shown in step 755, where feedback is received from the called party about a call he or she received, this feedback being explicit (such as by answering a query sent to the device of the called party) or implicit (by hanging up the call quickly, whether “quickly” is by way of time or by way of acceleration of the device from the called party's ear downward, as detected by an accelerometer).

Another aspect of the calling party can be keywords used by the calling party during the call. Speech recognition and transcription of the call (step 710) can be used to find these keywords (steps 725 and 730) and can be taken into consideration when deciding whether to forward or not forward the call (which happens upon detection of urgency). This is described with reference to FIG. 6, with the prior examples of “son” and “cat” in more detail. Another aspect of the call, also described above, is the caller identification information (step 720). The caller is identified based on CallerID information, recognizing the caller's voice as being that of a previous caller, or the like. Such information can also be used to determine the location of the calling party and then, based on their location, deem the call urgent or not urgent. The location or identity of the calling party can also be determined simply by asking the calling party to state, during the phone call, his or her location or name. If the location is within a certain distance to another denied call or another call determined to be urgent, then the call might or might not be sent to the called party who is unavailable.

In step 715, the tone or speed the caller's speech can also be used to determine urgency. An urgent caller might speak in a higher pitch or speed, above a predesignated threshold. A tonal change between a first and second time period during a call can also be used to determine urgency. For example, a caller may speak fast at first, but, after being prompted with a question, speak more slowly, versus another caller who continues to speak just as fast or at the same tone as previously. With all of these aspects, prior calls which were determined to be urgent can be compared with a present call to determine if the call is urgent, and feedback (step 755) from a called party can be used to make such determinations. The feedback from a particular called party might apply for future calls to that called party, or to any called party where a network nodes carries out aspects of the disclosed technology.

Still other aspects of the call in step 705 can include the sex of the caller (a particular called party may decide that calls from females should get through even if he's “unavailable” for example), or this may be decided based on his past habits, and/or based on the outcome of other calls and/or his feedback in step 755. Another aspect is time on the call until urgency is detected. Again, this can be used as a function to compare to later calls which take just as long, depending on how the called party reacted to the call. For example, if the call goes on for two minutes before “fire” is detected, perhaps this call isn't urgent, whereas if it is said in the first 10 seconds or during the first or second answer to a query, then it is urgent.

Thus, as described above, once aspects of the calling party are determined in step 705, including aspects of the speech and characteristics thereof, such as shown in steps 710 through 730, these aspects are compared to prior calls in step 735 of embodiments of the disclosed technology. This is also, or instead, compared to predesignated or entered data in step 740, in some embodiments of the disclosed technology. For example, see the above discussion about a maximum time frame for the call until urgency is detected—this maximum time frame can be determined based on predesignated data indicating a maximum time, or by determining this from where prior calls were found to be urgent, and/or confirmed to be urgent by the particular called party being called now, or a plurality of different called parties using the system. Based on this, urgency can be detected in step 645, in which case even when urgency is detected, the call can be denied in step 750, due to one of the aspects of the calling party or speech within the call, as described above. If the call to the called party is still denied in step 750 or urgency is not detected, then the call is not forwarded to the called party. Step 655 is carried out and a message is sent to the called party, as described with reference to step 655 in FIG. 6. The calling party, in some embodiments, is notified that his or her call has been deemed non-urgent. In other embodiments, no such notification is given, and the call simply ends after a message is left for the called party, or a notification is given that the call is ending.

Note that in step 735, where the prior calls are compared, this can be based on feedback from the called party being called, or other called parties in other calls, in step 755. In some embodiments, the called party is prompted after sending the message to the called party in step 755, or the call to the called party ends after step 650. A query, whether by audio or visually, exhibited, is sent to the calling party, asking, “Should this call have been sent to you despite your unavailable status?” Of course, any like-kind query can be made requesting whether or not the called party wanted to receive the call. The called party can then respond positively or negatively, and, in some embodiments, why this is so. These answers can then be taken into account when comparing prior calls in step 735, based on like-kind aspects of a prior call and a present call, such as any of the aspects described above or determined in step 705. In some cases, the called party might be asked a further question, such as, “is it because this was a family member that you wanted to receive the call?” or another question based on an aspect of the call which was determined. As such, confirmation of an aspect of the call which is important or non-important to the called party can be determined. Another such query might be, “this person said ‘cat’ during the call. Is that a subject worth sending you calls about if you are unavailable?” Thus, a keyword can be used for future calls based on the called party's desires about the keyword, or the system can simply determine same by a rejection of a prior call in which the term was used.

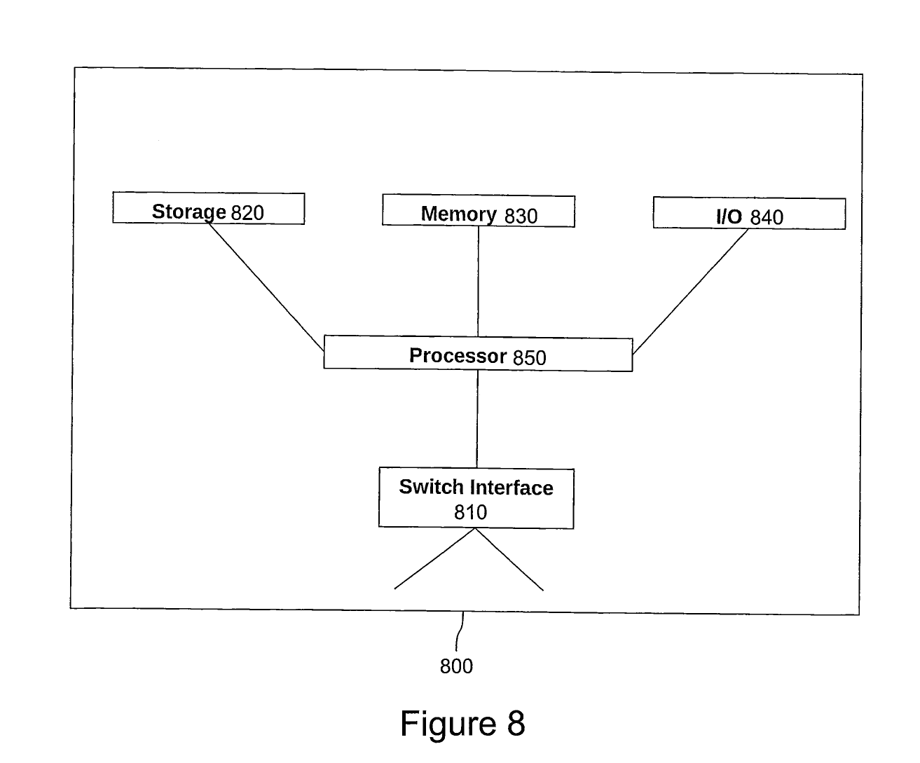

FIG. 8 shows a high-level block diagram of a device that may be used to carry out the disclosed technology. Device 800 comprises a processor 850 that controls the overall operation of the device, by executing the device's program instructions which define such operation. The device's program instructions may be stored in a storage device 820 (e.g., magnetic disk, database) and loaded into memory 830, when execution of the console's program instructions is desired. Thus, the device's operation will be defined by the device's program instructions stored in memory 830 and/or storage 820, and the console will be controlled by processor 850 executing the console's program instructions. A device 800 also includes one, or a plurality of, input network interfaces for communicating with other devices via a network (e.g., the internet). The device 800 further includes an electrical input interface. A device 800 also includes one or more output network interfaces 810 for communicating with other devices. Device 800 also includes input/output 840 representing devices which allow for user interaction with a computer (e.g., display, keyboard, mouse, speakers, buttons, etc.). One skilled in the art will recognize that an implementation of an actual device will contain other components as well, and that FIG. 8 is a high level representation of some of the components of such a device, for illustrative purposes. It should also be understood by one skilled in the art that the method and devices depicted in FIGS. 1 through 7 may be implemented on a device such as is shown in FIG. 8.

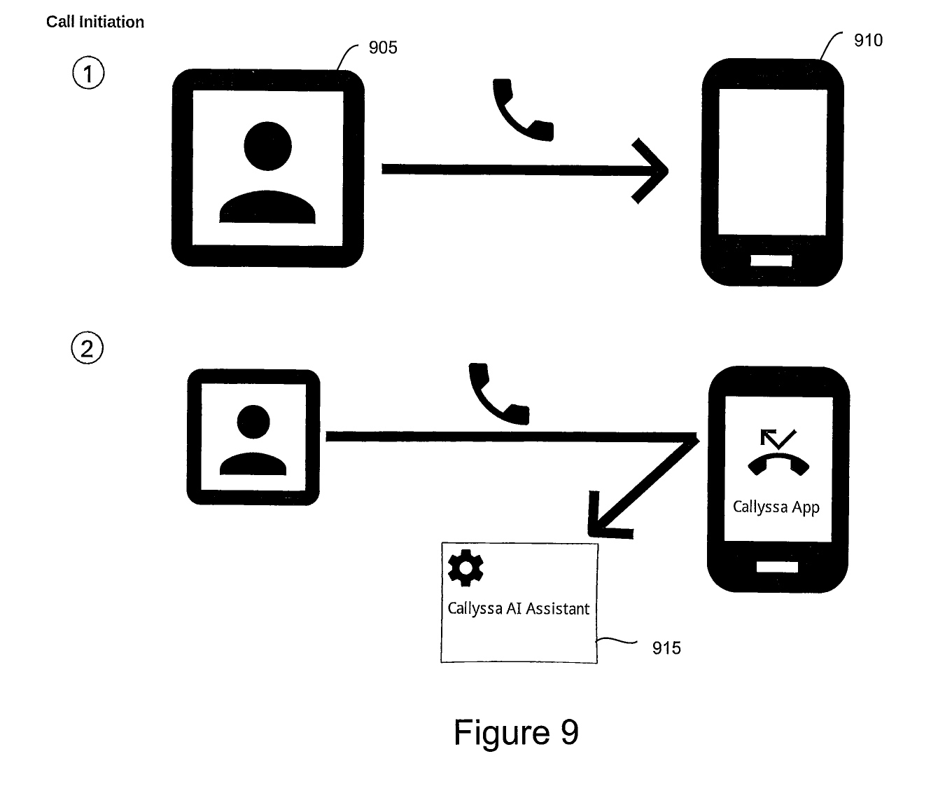

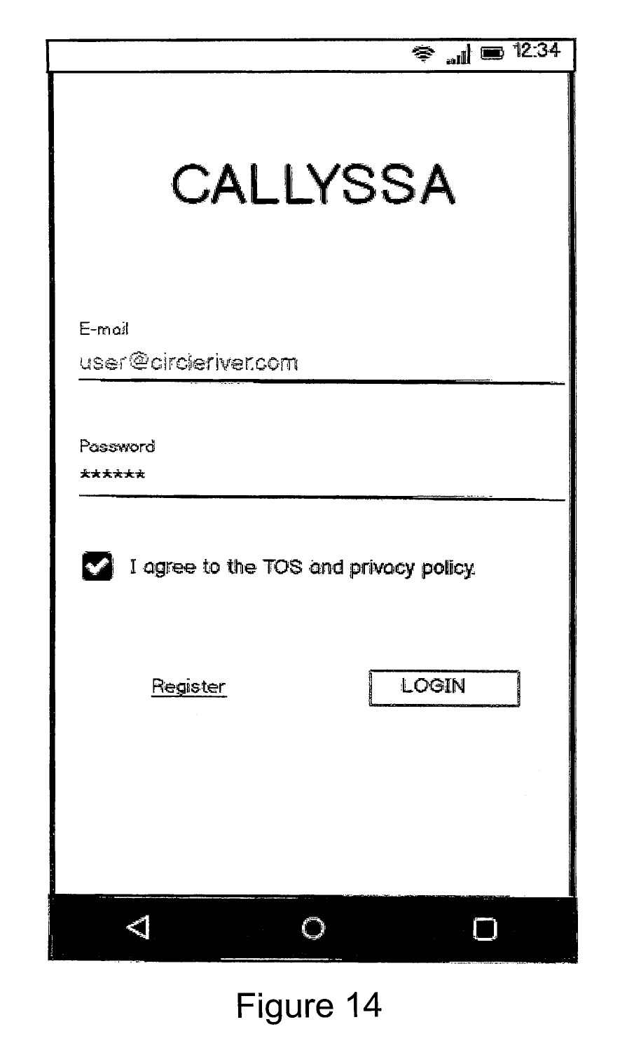

FIGS. 9-13 show another high level example of how a call is answered, transcribed, and manipulated, in embodiments of the disclosed technology. Referring to FIG. 9, the process starts with receiving a telephone call from the calling party 905 that is directed to the called party 910 (e.g., a particular person or business entity). The call is transmitted from the calling party's bidirectional transceiver. The called party's transceiver is installed with a module or app configured to transfer the call to a remote computer on which the artificial intelligence is implemented (sometimes referred to as module residing on the called party's transceiver). In one embodiment, the module transfers the call by rejecting the call and directing the rejected call that is supposed to be sent to the voicemail of the called number to the remote computer. The module modifies the default IP address or telephone number of the voicemail to be the IP address or telephone number of the remote computer so the call can be directed accordingly upon rejection. The module is also configured to provide other functionality described in FIGS. 14-22. In some embodiments, the call can be directed to the remote computer without going through the called party's transceiver. As such, the call can be received via the called party's transceiver, the remote computer, or both. Module refers to software module that is executed by the called party's transceiver for carrying its functionality. The remote computer is a distributed system including network node 134, speech recognition engine 140, and/or speech synthesizer 150 as shown in FIGS. 1 and 5 that are linked together by a network. The network can be a local area network (LAN) or a wide area network (WAN), but can also be other wired or wireless networks. The network may be the Internet or some other public or private network. The network may be established by optical fibers, Ethernet cables, Wi-Fi, 802.11, Bluetooth, 900 MHz, 1.4 GHz, and 5.6 GHz radio frequency, infrared, GSM, GSM plus EDGE, CDMA, quadband, other suitable communications protocol, or a combination thereof. The call is transferred to the AI 915 created by the remote computer to obtain details of the call or the calling party. The call is always transferred to the AI regardless of the called party's availability so that the called party would never need to answer the call until the AI determines that the call should be forwarded to the called party. The call can be automatically transferred by the called party's transceiver or manually transferred by the called party via the module.

The details that can be obtained by AI include one or more of the calling party's telephone number, the calling party's location, the calling party's name, the calling party's voice, the calling party's organization, the purpose of the calling party's call, call content based on keyword, password or other call description, or reason for the call. Other call description can include information without keyword or password. Details including call content based on keyword or password can determine the purpose of the call (e.g., the cat needs to eat or where is the cat food stored?). Details including call content based on other call description can be a summary of the call or paraphrased statements of statements made by the calling party without determining the purpose of the call (e.g., whether or not the calling party is a good mood). The calling party's telephone number, location, name, voice, or any combination thereof may be referred to as identification information.

The AI can obtain these details by checking the CallerID and ANI data, by asking questions directed to those information, or both. In some embodiments, the AI obtains these details by checking the CallerID and ANI data without verbally communicating with the calling party. In some embodiments, the AI obtains the details by asking questions or by checking the CallerID and ANI data and asking questions. The questions may be pre-programmed into the AI such that it always asks the same questions. The answers to the questions may be the details the AI wants to obtain. The questions may also be constructed from the responses received from the calling party using a generative model (except the first question that may need to pre-programed if the AI is configured to start the conversation first). The AI may also provide answers to the questions from the calling party. The questions and answers from the AI change according to the answers and questions received from the calling party. The AI can understand or analyze the content in the answers and questions from the calling party (through a trained neural network or trained AI, a statistical machine learning, or a semantic analysis) and provide questions and answers relevant to or based on the content. In some embodiments, the content may further include answers and questions from the AI. As such, the AI can analyze the content in the answers and questions from the calling party and the content in the answers and questions from the AI. This further inclusion or analysis may allow the AI to provide more accurate or detailed questions and responses. The content, whether from the calling party or both the calling party and the AI, may also be known as call content. Regardless of whether the AI's questions are preprogrammed, content-based, or generative, the AI queries the calling party to obtain sufficient details of the call or calling party to enable the AI to process the call. The AI is configured to speak in natural language. All the obtained details can be forwarded to and displayed on the called party's transceiver in real-time.

Based on the obtained details and call processing criteria associated with the AI, the AI can determine how to process the call including whether the call should be forward to the called party. The call processing criteria can refer to a rule or a set of rules that determine what criteria or how many details need to be obtained and how many of the obtained details need to match to information that is available or knowledge of the AI. The call processing criteria determine the level of call screening. The more details need to be obtained and the more obtained details need to match, the less calls would be forwarded to the called party and vice versa. In one arrangement, the AI can determine immediately how to process a call based on a single item of information, such as caller ID. For example, an incoming call from a telephone number that is known to be of an authorized caller can be immediately forwarded to the intended recipient. Alternatively, a number that is known to be associated with a spammer or from an entity whose calls are not desired can lead the AI to immediately hang up on the caller without obtaining further details. Therefore, in certain situations, the AI does not need to interact with the caller but can process the call automatically either by forwarding it directly to the intended recipient or by hanging up on a call that is not wanted. In many other situations, however, the AI would answer the call in order to obtain additional details or criteria that would allow the AI to determine how to process the call. The rule or rules that are set up will determine how much information should be obtained before the call can be properly processed. In the event that the AI cannot obtain the necessary information to process the call, a default arrangement can be set, e.g., forwarding the call to voice mail or asking the caller to call back later.

The call processing criteria can be manually set by the called party via his or her transceiver or automatically set by the AI according to the called party's call history (e.g., the called party took calls from this calling party, the called party never took calls from this calling party, the called party sometimes took calls from this calling party and sometimes did not, etc.). Such setting allows the AI to forward only the calls the called party wants to accept. For example, the calling processing criteria can be set to obtain any two details (e.g., randomly selected by the AI) or two specific details (e.g., the calling party's telephone number and location) and that both details need to match the information that is known to the AI in order to forward the call. In some embodiments, the number of details need to be obtained and the number of obtained details need to match may be different. Information that is available or knowledge of the AI may include telephone numbers, locations, names, and voices of calling parties, previous call content between the AI and the calling party, calling party categories (e.g., family, friend, business, spammer, etc.), or any combination thereof. These information can be pre-entered and pre-stored by the called party via his or her transceiver, stored by the AI from received incoming calls, or both.

In addition to call forwarding, the AI can process the call by taking a message from the calling party, directing the call to voice mail, directing the call to a third party, scheduling a meeting or callback on behalf of the called party, receiving a reminder for the called party, or terminating the call based on the obtained details and call processing criteria. The AI may also provide basic information to the calling party, such as email address and current location of the called party and business hours and location of the called party (if the called party is a business), if the calling party is a person authorized to receive such information. Each of these actions is performed after the call is answered and without requiring input from the called party.

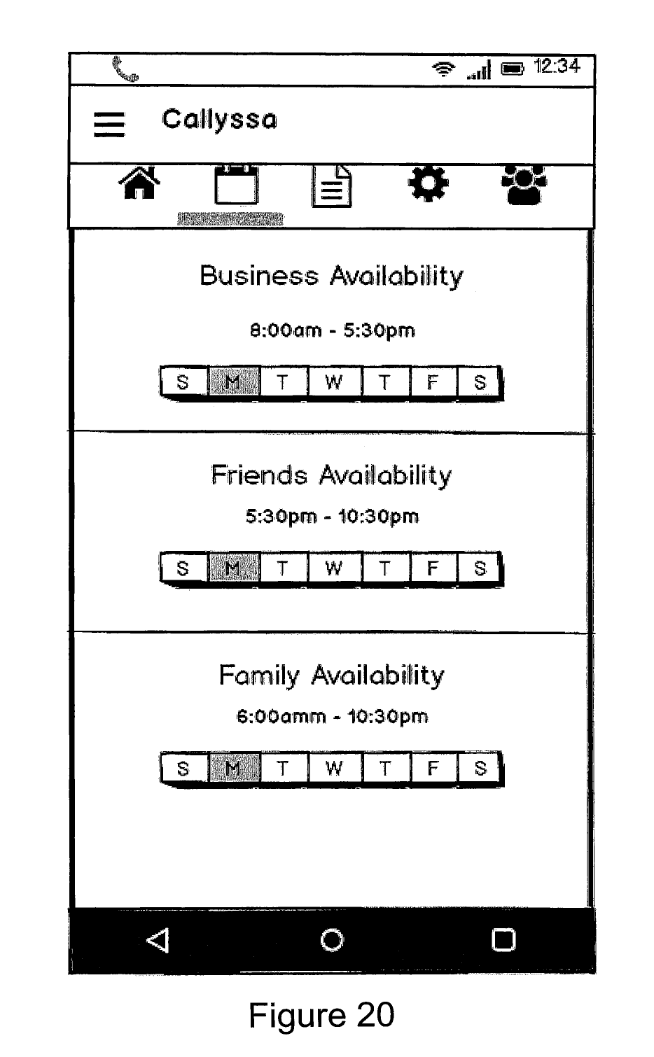

Moreover, the determination of how to process the call can further be based on whether the called party is available or not. Availability can be determined by a calendar, a notification on the called party's transceiver, whether the called party is on the phone, whether the called party is at a certain location, whether the called party is historically unavailable at the time of the received call, a notification to the AI from the called party, or any combination thereof. The calendar can be an electronic calendar on the called party's transceiver, an electronic calendar in the module as shown in FIG. 20, or a cloud-based calendar that is accessible by the called party's transceiver. The notification on the called party's transceiver can be a notification generated in response to an input to a physical component of the called party's transceiver by called party indicating that he or she does not want to answer calls. For example, the called party may press the volume button to silence the transceiver. The notification can also be generated in response to an input to a software of the called party's transceiver by the called party indicating that he or she does not want to answer calls. For example, the called party may use another application different from the electronic calendar to indicate the called party's availability or that provides information from which the called party's availability can be inferred. The certain location may be one of the locations from where the called party would accept or reject the call. The locations that the called party would accept or reject the call can be setup by the called party through the module or automatically determined by the AI through call history. For example, the called party's history may indicate that the called party always accepted calls form location A and always rejected calls from location B. Whether the called party is historically unavailable at the time of the received call can refer to whether there was one or more instances in the past where the called party rejected or did not answer a call that was received at the same time or about the same time as the received call. The notification to the AI from the called party can also be made through the module. When the called party is not available, the call may not be forwarded to the called party. In some embodiments, however, the call may still be forwarded to the called party depending on the obtained details and call processing criteria (e.g., the called party may always want to receive calls from family members). When the called party is available, whether the call should be forwarded would depend on the obtained details and call processing criteria.

According to the present invention, the AI has the ability to learn from previous call processing how to more efficiently process future calls. For example, if a solicitor calls from a particular phone number that is eventually determined to be one that should not be answered, the AI can recognize other calls having similar numbers or being from the same institution or business to be able to immediately block those calls without further inquiry. Similarly, a call that is recognized as being acceptable either from caller ID, voice recognition, caller name or other single items of information, can be used to process future calls where the similar information is identified, such as the same caller name but from a different phone number.

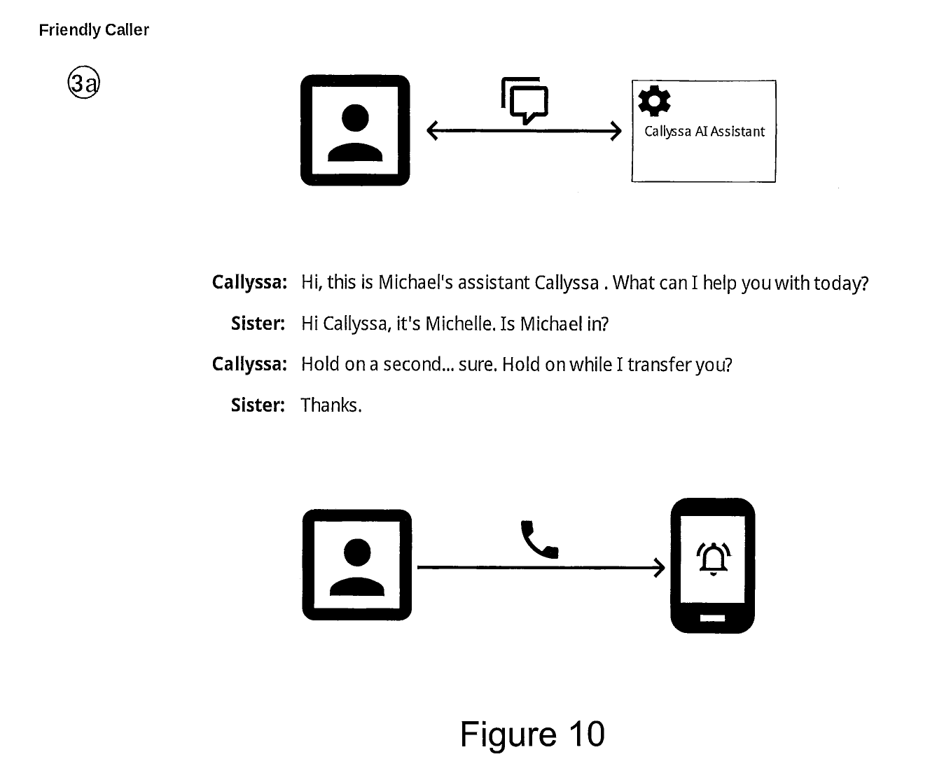

FIG. 10 depicts an illustrative call that is determined to be forwarded to the called party, in embodiments of the disclosed technology. The AI is configured to start conversation with the calling party. In some embodiments, the AI can be simply configured to wait for the calling party's before asking the called party any questions. The calling party responded to the AI's question by saying she is Michelle and asking if Michael is in. At this point, the AI can analyze the response based on the obtained details, call processing criteria, and/or the called party's availability as discussed above. For example, based on the word “Michelle” and the telephone number of the calling party, the AI determines that both details match to the information that are known to the AI. The match may generate a result indicating that the calling party is the called party's sister. The word “Michelle” and the telephone number of the calling party may already be stored into the AI by the called party or stored by the AI based on the called party's call history (because the called party has always accepted a call that has these two pieces of detail) as details that the call can be forwarded. In this example, the call processing criteria is set to obtain at least two details and both details need to match to the information that are known to the AI. In other situations, the AI can obtain only one detail or more than two details. For example, the only one detail can be the calling party's voice for stricter determination since only one detail is needed to determine call forwarding. When more than two details are needed, the calling party's location or other information are further obtained, in addition to the word “Michelle” and the telephone number of the calling party. FIG. 10 depicts an illustrative conversation between the AI and an incoming call from a recognized family member, friend, or colleague. In this situation, the AI forwards to the call to the called party.

The AI can further determine that the called party is available. Since the analysis based on the obtained details and call processing criteria shows that the calling party is the called party's sister and the called party is available, the call is forwarded to the called party. In some embodiments, the called party can be unavailable and the call can still be forwarded to the called party because the called party configured to the AI to make calls with such details as an exception or because the called party's call history has shown that the called party has always taken calls with these details even when the called party is unavailable and the AI atomically makes such calls as an exception based on that history. Furthermore, when the called party is unavailable, the AI, using a trained neural network, statistical machine learning, or semantic analysis, may determine that the call is of sufficient elevated importance or urgency that the call may be forwarded to the called party despite the unavailable status.

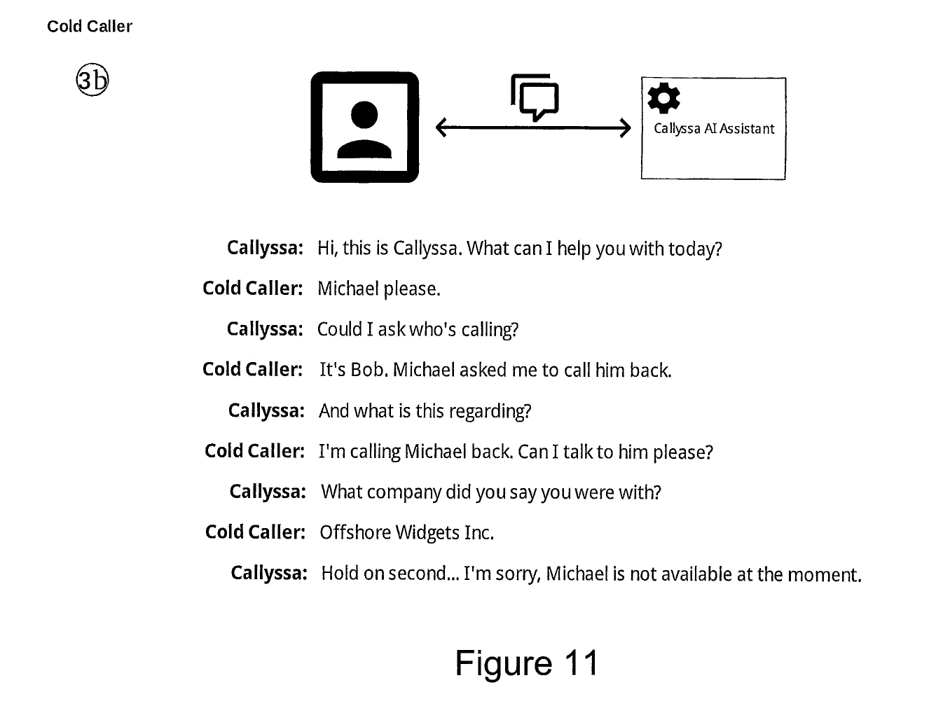

FIG. 11 depicts an illustrative call that is determined not to be forwarded to the called party, in embodiments of the disclosed technology. The AI is configured to start conversation with the calling party. The AI may determine from the CallerID and ANI data that the name and telephone associated with the call or other information do not match to any information known to the AI. In the alternative or in addition to the CallerID and ANI data, the AI may also determine that the first response from the calling party “Michael please” or the calling party's voice does not match to any information known to the AI. In this situation, the AI may continue to query the calling party. Since the AI determines that the first response does not include the calling party's name, the AI asks who is calling. Once the calling party provides his name, the AI asks another question to obtain another information or detail. The AI repeated these steps until it obtains sufficient details to enable it to determine how to process the call. Each question by the AI is based on call content, such as based on the latest answer or question from the calling party, based on one or more of the answers or questions from the calling party, based on one or more of the answers or questions from the AI, or based on a combination of one or more of the answers or questions from the calling party and one or more of the answers or questions from the AI. With the obtained details and the call processing criteria, the AI can determine whether it should forward the call to the called party. The calling party's tone can also be considered in determining the next question to be asked by the AI and whether the call should be forwarded.

Based on all these information, the AI can determine that the call should not be forwarded by communicating to the calling party that the called party is not available even though the called party is available. FIG. 11 may depict how the AI would handle a cold caller who is not known to the called party or who the AI detects is an unwanted caller, such as solicitation for unwanted business.

The determination can further include the called party's availability. The AI can determine that that the call should not be forwarded because the called party is in a meeting. The called party's availability can be checked by the AI last or after asking enough questions so the AI can determine whether it should forward the call despite that the called party is unavailable. This is because the called party may still want to take a certain calls even when he or she is busy. In some embodiments, the called party's availability can be checked first (e.g., upon the AI receives the call and before the AI asks any question). In those situations, the AI can immediately tell the calling party that the called party is not available without engaging the calling party in conversation. In some situations, the AI can still engage the calling party in conversation upon such determination so the AI can decide whether it should forward the call to the unavailable called party (or override the called party's unavailability). The called party's availability can also be determined in other order, with or without engaging the calling part in conversation. Calls not forwarded to the called party can be processed by taking a message from the calling party, directing the call to voice mail, directing to a third party, scheduling a meeting or callback on behalf of the called party, receiving a reminder for the called party, or terminating the call. All these actions are performed without requiring input form the called party.

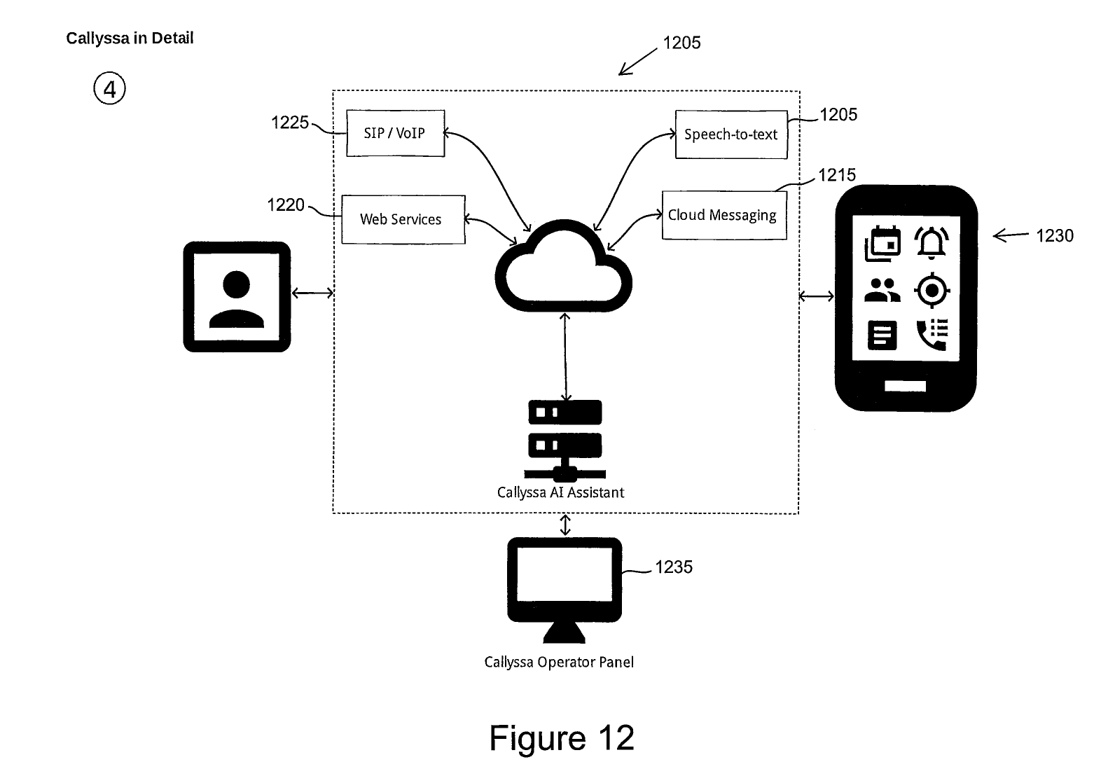

FIG. 12 depicts illustrative components of the AI 1205, in embodiments of the disclosed technology. The AI 1205 can be cloud-based running on Amazon Web Services. The server may include the network node 134, speech recognition engine 140, and/or speech synthesizer 150 as shown in FIGS. 1 and 5 or may be in electrical communication with those devices to enable it to perform the functions of those devices. With these devices, the server can execute speech-to-text transcription 1210, cloud messaging 1215, and web services 1220. Cloud messaging 1215 allows the AI to push messages to the called party's transceiver 1230, such as reminders to the called party based on the calendar, information showing the name and location of the calling party, and notification that a call has been answered by the AI and there is live ongoing conversation between the AI and the calling party. Web service 1120 may be any service that can be remotely accessed by the AI 1205 via the Internet to expand the AI's functionality. SIP/VoIP service 1225 can be provided to the AI by a third party SIP/VoIP provider that takes voice calls and processes them to meet interne protocols for transmission and/or reception.

The server may also include an operator panel 1235 from which a monitoring person can train the AI 1205, monitor the conversation between the AI 1205 and the calling party in real-time, and change or override the decision (e.g., question, answer, or processing decision) made by the AI in real-time. The conversation can be monitored through the live transcript. The panel 1235 can be located on the same site as the server 1205 or at a different site. When the AI is setup for the first time, the AI may not have any decision-making capability. The AI can be trained by the monitoring person making decisions for the AI so the AI would learn what decision it should make under the same or similar response (also known as supervised training). Once the AI learns enough decision, the AI may operate on its own without assistance from the monitoring person. The monitoring person may monitor the decisions by the AI periodically and correct its decision for improvement. The monitoring person can be an AI trainer, the called party himself or herself, or any other person who is interested in monitoring the conversation between the AI and the calling (such as tech support person). The monitoring person and the called party may also be two different individuals. In that situation, the live transcript can be sent to both individuals and be viewed by both individuals in order for each individual to take the appropriate action.

The AI can be trained from providing examples and giving answers to the examples. The AI can be provided with example or historical questions and answers from the calling party and be instructed to make a decision (e.g., forward the call, take a message, direct to voice mail or third party, etc.) for each example or historical question and answer. The same example or historical questions and answers can be fed to the AI repeatedly to strengthen the AI's decision-making capability. The training can continue for days until the AI reaches a desired accuracy. The training is completed before the AI is put into operation. In some embodiments, the AI can be trained during operation. The AI receives real questions and answer from the calling party in real-time and is instructed to make a decision for each real question and answer in real-time. In some embodiments, the AI can be configured with modules or algorithms with some basic detail-obtaining capability and decision-making capability. The monitoring person can assist the AI in obtaining further details, in making decisions, or both so the call can be properly processed. The AI can then either remember the decision or correct the decision it made. The training can be achieved through the utilization of neural network, support vector machine, k-nearest neighbor algorithm, Gaussian mixture model, naive Bayes classifier, Bayesian system, decision tree, and other technique.

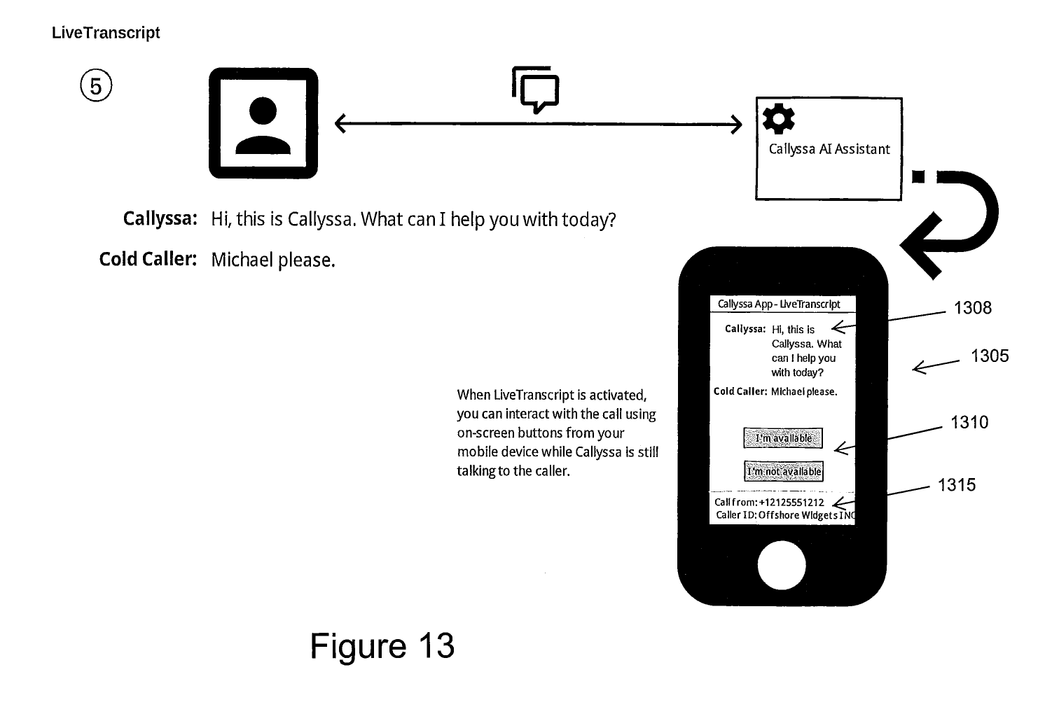

FIG. 13 depicts another illustrative live transcript of audio between the calling party and the AI, in embodiments of the disclosed technology. The audio is transcribed by the AI in real-time and the transcript is transmitted to the called party's transceiver 1305 by the AI in real-time. The live transcript 1308 allows the called party to determine if the AI's processing is appropriate and/or alter the behavior of the AI in a specific instance. The live transcript 1308 is supplemented with selectable elements 1310 through which the called party can interact with the call while reading the live transcript and while the AI is verbally communicating with the calling party. The called party can indicate via selectable elements 1310 whether he or she is available and the AI can process the call accordingly. In addition to the two selectable elements 1310, the screen of the called party's transceiver 1305 can further display other selectable elements as shown in FIG. 4. The selectable elements also allow the called party to override the determination made by the AI. For example, when the AI determines that the call should be forwarded to the called party, the called party may override that determination by instructing the AI to direct the call to voice mail via the corresponding selectable element. The override can occur when the AI makes an indication (e.g., on the live transcript) that it is going to perform an action (e.g., forwarding the call to the called party) and before the AI performs that action. In some embodiments, the override can also occur after the AI performs the action. The calling party's telephone number and name 1315 and other obtained detail may also be displayed simultaneously with the live transcript 1308. The live transcript can be saved in the AI, the called party's transceiver, or both. The live transcript can allow the called party to take action in real-time (e.g., present action) in deciding whether to answer or return the call or not or take other action. The live transcript can also allow the called party to take action at a later time (e.g., future action) when the same calling party calls again in deciding whether to answer or return the call or not or take other action. The audio may also be recorded and be saved.

FIGS. 14-22 show an illustrative module residing on the called party's transceiver that is implemented to configure the artificial intelligence, in embodiments of the disclosed technology. Although the module is implemented on Android in these figures, the module may also be implemented on iOS, Windows, or other operating system. FIG. 14 depicts an illustrative login screen of the module. The login screen may ask for the called party's email address and password when the called party is a registered user. If the called party is not a registered user, he or she can activate the “register” element and begin the registration process. The module and/or AI is dubbed “Callyssa.”

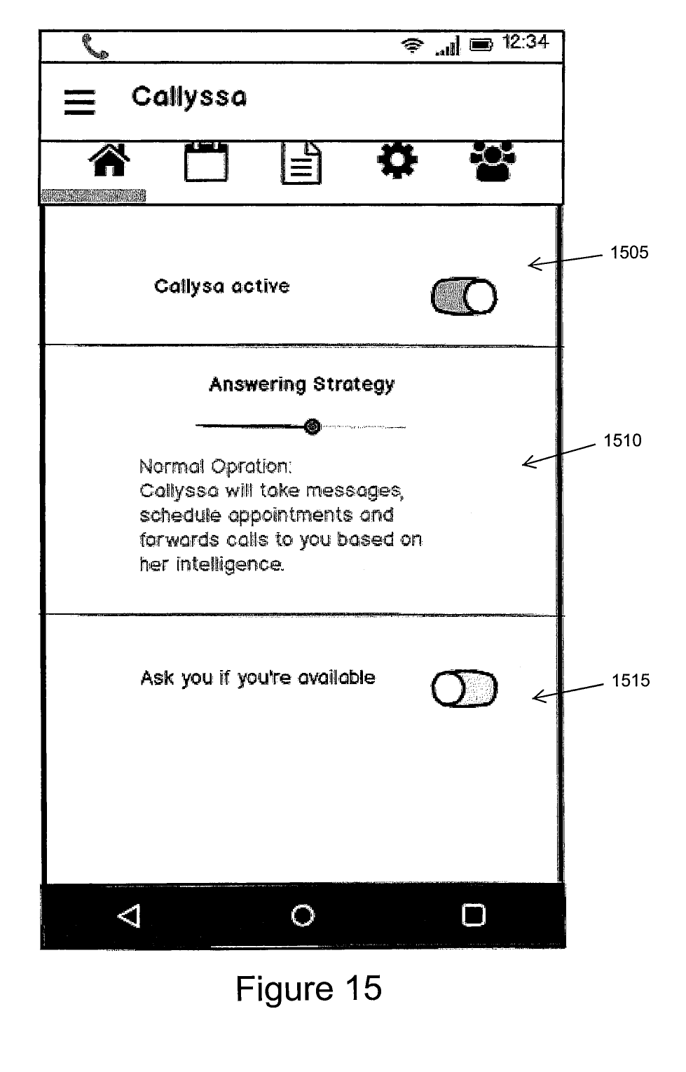

FIG. 15 depicts an illustrative main screen of the module. The main screen may comprise a first digital button 1505 configured to activate to the operation of the AI, a second digital button 1510 configured to control the level of call screening, and a third digital button 1515 configured to set the availability of the called party. The first digital button 1505 can turn on or off the operation of the AI (or the module), and the operation is currently set to active. There may be situations where the module is not needed and the called party would prefer to receive all calls. In those situations, the module can be turned off. The second digital button 1510 can be implemented as a slidable button that can vary the level of call screening after the AI is activated. The slidable button can be constructed to be slidable across a distance and to be slidable by the called party to any position on the distance. This is different from the first and third buttons in that the first and third buttons only provide two options or are movable to only two locations (on or off and available or unavailable). This is also different from a button movable over a plurality of pre-defined marks with each mark indicating a different level of call screening because the button cannot be moved to a position between each mark (or any position). In some embodiments, however, the second digital button 1510 may be implemented similar to the first and third buttons with only two options, as movable over a plurality of pre-defined marks, or with any number of options or in any other form. By varying the level of call screening, it changes the call processing criteria. The second digital button 1510 is currently set to around medium or moderate screening which configures the AI to take messages, schedule appointments, and forward calls to the called party based on its intelligence or determination. Sliding the button toward one direction (e.g., left) can configure the AI to more likely taking messages or scheduling appointments. Sliding the button to one end (e.g., left end) can configure the AI to only take message or schedule appointments without forwarding any call to the called party. Sliding the button toward another direction (e.g., right) can configure the AI to more likely forwarding calls to the called party. Sliding the button to another end (e.g., right end) can configure the AI to forward all the calls to the called party. Sliding the button toward another direction or another end can also configure the AI to rely its decision more or completely on the called party's input, the input from a live operator, or the input from the monitoring person. The third digital button 1515 can be set to indicate that the called party is available or not available. When the button 1515 is set to available, the called party will always be notified of a call that the AI has determined should be forwarded to the called party and be given the chance to reject or accept the call manually based on the call details in the notification. The button 1515 is currently set to unavailable or not send such notifications to the called party.

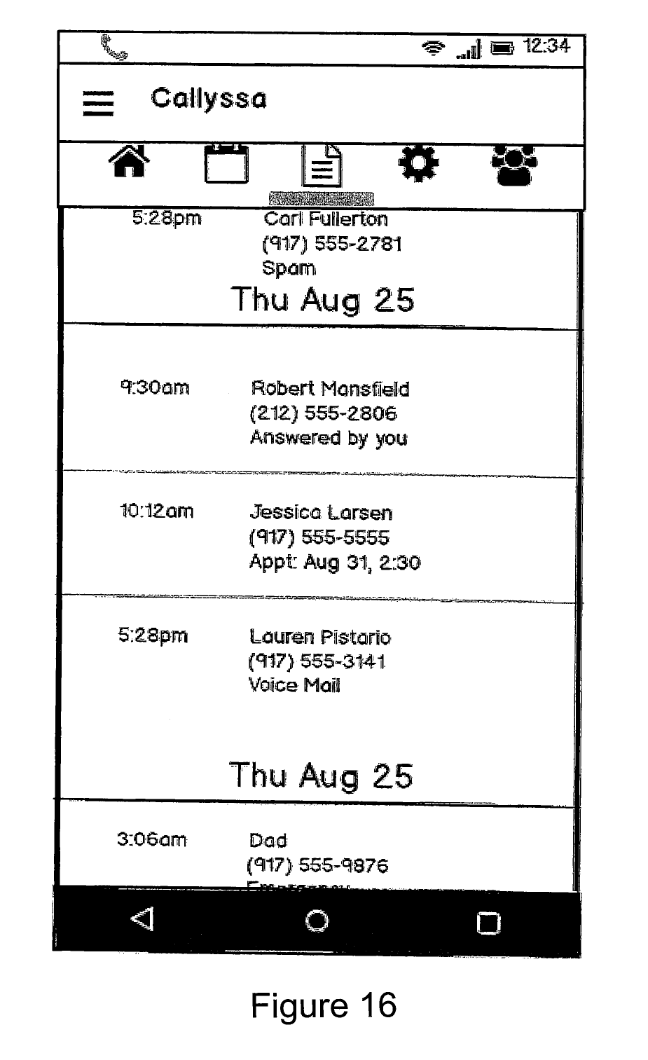

FIG. 16 depicts an illustrative call history screen of the module. The call history screen may show the date and time and the calling party's name and telephone number of each previous call. The call history screen may also show how the call was processed by the AI or handled by the called party. For example, the first call (from the top of the screen) came from Carl Fullerton. From the CallerID and ANI data and/or the conversation between the AI and the calling party, the AI may have determined that this call was a spam. As such, the AI processed the call by terminating the call and indicated the call as a “spam.” The AI may also have stored this calling party or telephone number in the blacklist. The second call came from Robert Mansfield and the AI may have determined that Robert was an authorized calling party and that the called party was available. As such, the AI processed the call by forwarding the call to the called party. Once the called party answered the call, the AI indicated the call as “answered by you.” The third call came from Jessica Larsen. The AI may have determined that the calling party needs to speak to the called party and that the called party was unavailable at the moment. As such, the AI processed the call by making an appointment with the calling party and the call party and displaying the appointment date and time. The fourth call came from Lauren Pistario. The AI may have determined that the call was just a reminder and that the called party was unavailable at the moment. As such, the AI processed the call by directing the call to voice mail and indicated the call as “voice mail.”

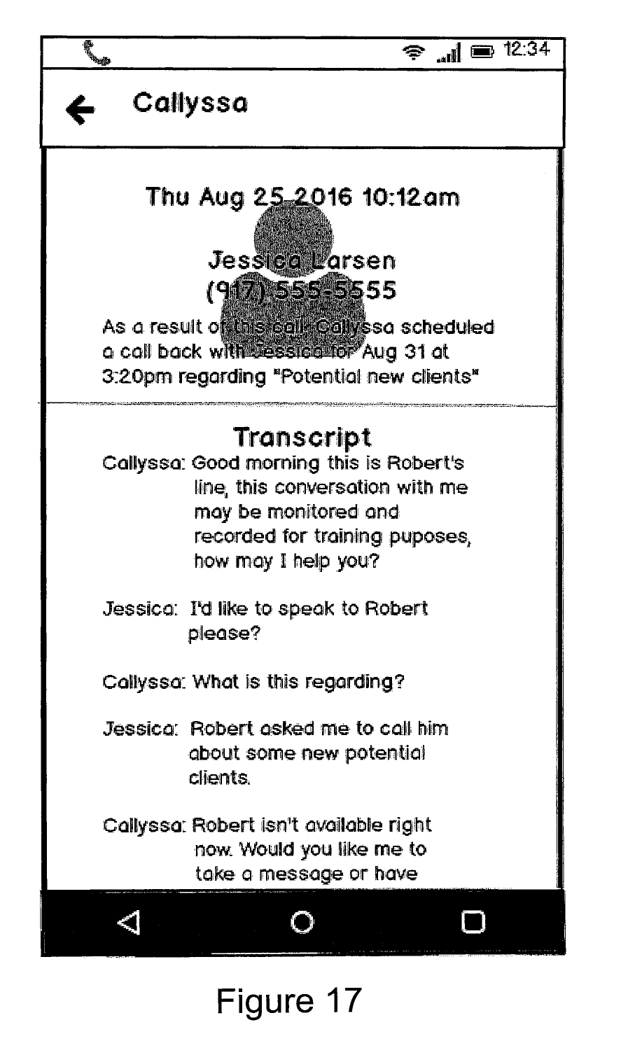

FIG. 17 depicts an illustrative saved appointment with Jessica Larsen. The appointment may be saved to an electronic calendar on the called party's transceiver, a cloud-based calendar that is accessible to the called party's transceiver, and/or the call history screen where Jessica's call information is displayed for future review. Therefore, the called party may view the detail information of the appointment from the calendar or call history screen. The detail information may include the date and time the calling party made the call, the name and telephone number of the calling party, the date and time of the appointment, and the subject of the appointment. The appointment can be in-person meeting or telephonic meeting. In this example, the AI scheduled a telephonic meeting and indicated that the called party should initiate the call. A transcript may also be provided with the detail information of the appointment so the called party can view what was conversed between the AI and the called party and be prepared for the appointment.

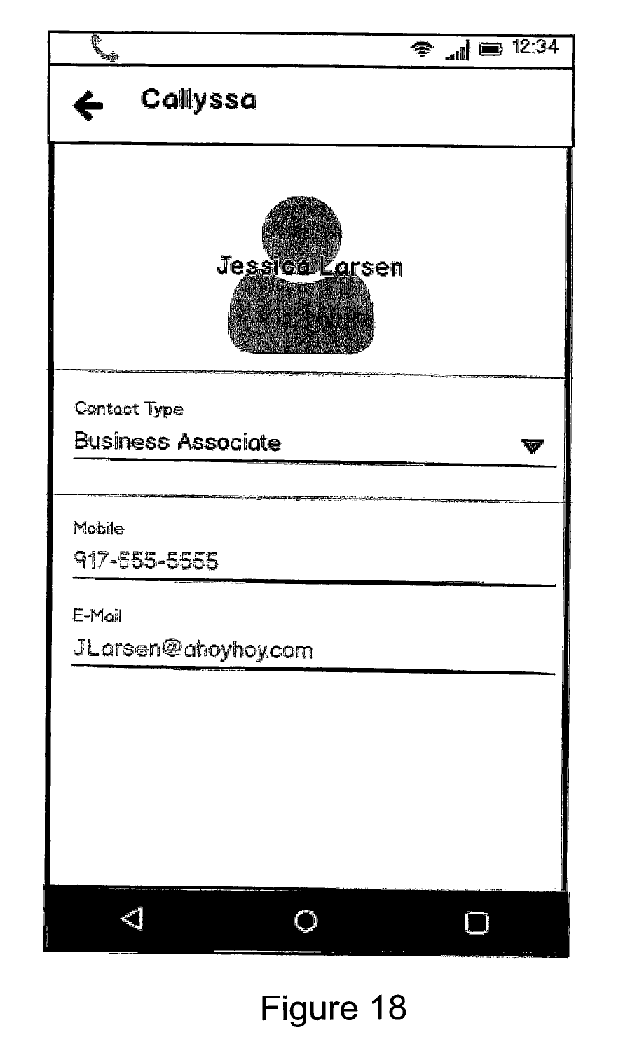

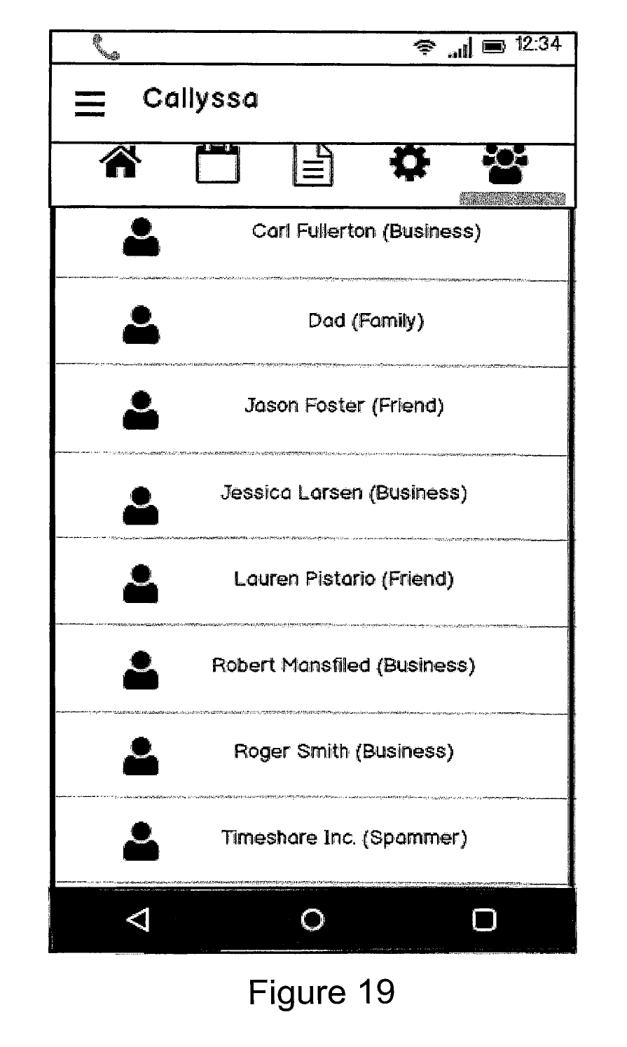

FIG. 18 depicts illustrative contact information of a contact. The contact information may include the contact's name, mobile number, E-mail address, and other information. The contact information may also include a digital button allowing the called party to set contact type. Contact type may include business (or business associate), friend, family, spammer, or other category, and setting the contact type puts the contact into one of the categories. Such setting helps the AI to process future calls from the contact. FIG. 19 depicts illustrative contacts and their contact type.

FIG. 20 depicts an illustrative availability screen of the module. The availability screen may comprise one or more digital buttons configured to set the called party's availability. One of the digital buttons may be configured to indicate the called party's availability to individuals or entities from business or work, one of the digital buttons may be configured to indicate the called party's availability to friends, and one of the digital buttons may be configured to indicate the called party's availability to family members. The buttons may allow the called party to specify the day and time of the week that the called party is available. The availability screen or each of the buttons may be in the form of a calendar. The availability screen may have other type of availability or availability button. The number and type of availability can match to the number and type of the contact type discussed in FIG. 18. Such setting helps the AI to process future calls from different categories.

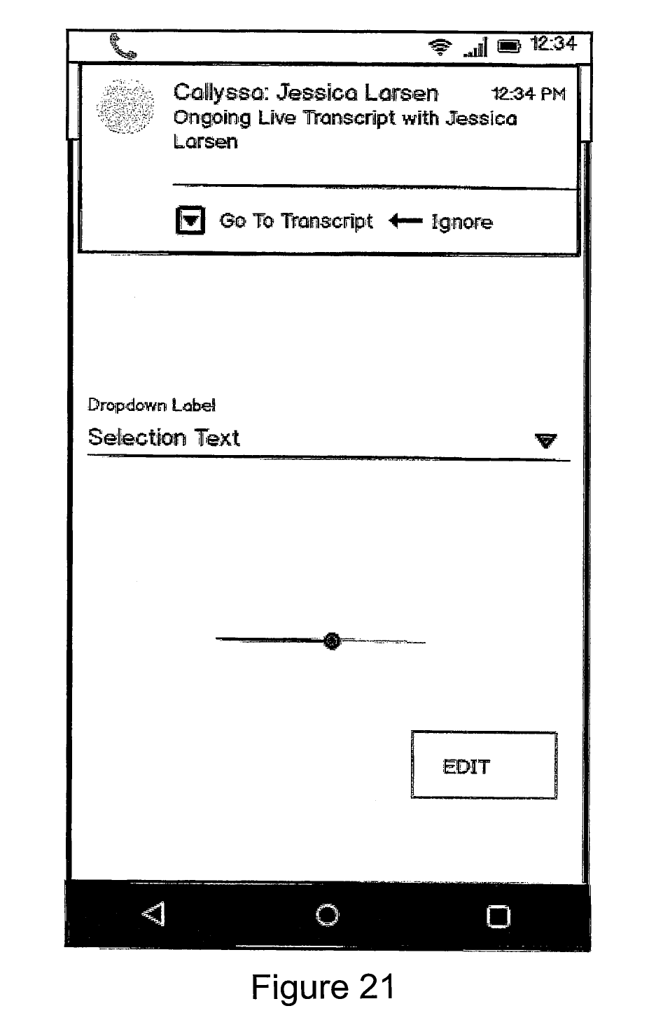

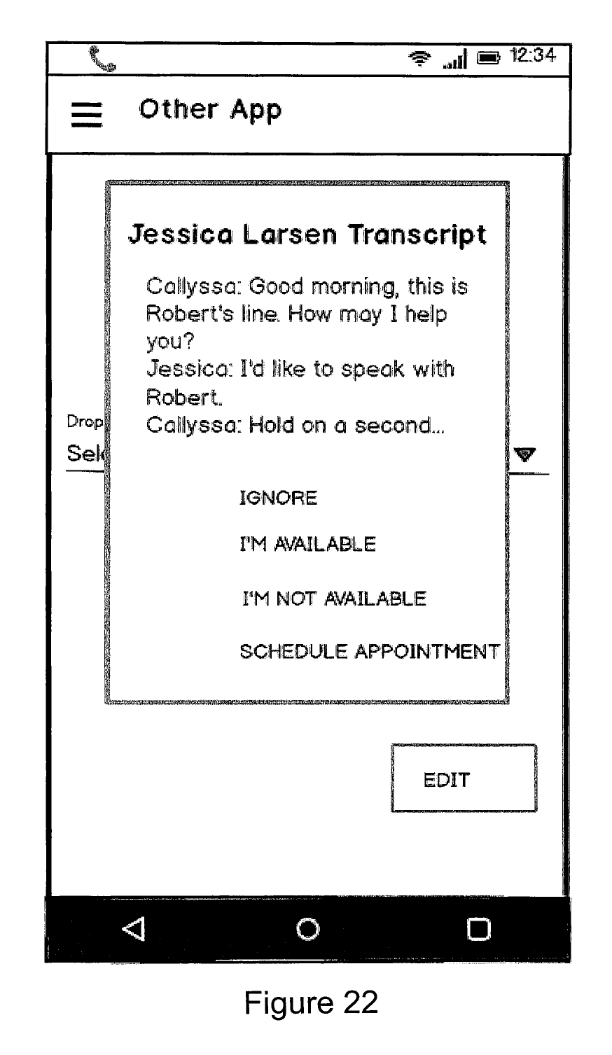

FIG. 21 depicts an illustrative call notification on the display of the called party's transceiver. When the call is transferred to the AI or when the AI starts communicating with the calling party, a call notification indicating ongoing live transcript with the calling partying may be pushed (e.g., transmitted in real-time) to the called party's transceiver. The notification may appear on the display of the transceiver regardless of which module or app the called party is currently using (e.g., can be displayed over any screen of a module or app). From the notification, the called party may choose to view the live transcript or ignore the notification. When the called party selected to view the live transcript, the live transcript is displayed along with selectable elements as shown in FIG. 22.

From the selectable elements, the called party can instruct the AI to take certain actions. The called party may simply ignore the ongoing conversation and let the AI makes its own determination. The called party may also indicate that he or she is available and the AI may immediately stop the conversation and forward the call to the called party. The called party may also indicate that he or she is not available and the AI may convey this information to the calling party and take a message from the calling party, direct the call to voice mail, direct the call to a third party, schedule a meeting or callback, or terminate the call. The called party may further advise the AI to schedule an appointment right away. The notification and live transcript can be pushed to and updated on the display via the Cloud messaging feature discussed in FIG. 12.

It should be understood that all subject matter disclosed herein is directed at, and should be read only on, statutory, non-abstract subject matter. All terminology should be read to include only the portions of the definitions which may be claimed. By way of example, “computer readable storage medium” is understood to be defined as only non-transitory storage media. The words “may” and “can” are used in the present description to indicate that this is one embodiment but the description should not be understood to be the only embodiment.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described herein-above are also contemplated and within the scope of the disclosed technology.

Thus for example any sequence(s) and/or temporal order of steps of various processes or methods or sequence of system/devices connections or operation that are described herein are illustrative and should not be interpreted as being restrictive. Accordingly, it should be understood that although steps of various processes or methods or connections or sequence of operations may be shown and described as being in a sequence or temporal order, but they are not necessary limited to being carried out in any particular sequence or order. For example, the steps in such processes or methods generally may be carried out in various different sequences and orders, while still falling within the scope of the present invention. Although specific systems/devices have been described, broader invention that would include some elements are also contemplated herein this disclosure.

What is claimed is:

1. A method of processing a telephone call from a calling party in order to determine the disposition of the call, which comprises:
receiving a telephone phone call from the calling party that is directed towards a particular person or business entity;
obtaining certain details of the call or calling party by artificial intelligence conversations with the calling party, wherein the artificial intelligence communicates with the calling party automatically and independently;
determining by the artificial intelligence how to process the call based on the certain details obtained during the conversations with the calling party along with separate call processing criteria that is provided to the artificial intelligence, so that the artificial intelligence can automatically determine to process the call by (a) forwarding the call to the particular person or to voice mail, or (b) forwarding the call to another person of the business entity or to a third party, or (c) providing a message or response to the calling party, (d) taking a message from the calling party and appropriately forwarding the message to the particular person, to voice mail, or to another person of the business entity, or (e) disconnecting or terminating the call.

2. The method of claim 1, wherein the artificial intelligence processes the call by forwarding the call to the particular person, taking a message from the calling party and providing the response to the particular person, providing a message from the particular person to the calling party, directing the call to voice mail, directing the call to another person or a third party, scheduling a meeting or callback on behalf of the particular person, receiving a reminder for the particular person, or terminating the call without requiring input from the particular person after the call is answered.

3. The method of claim 1 wherein the details obtained by the artificial intelligence includes one or more of voice recognition of the calling party, or by an identification of the calling party's telephone number, the calling party's location, the calling party's name, the calling party's organization, the purpose of the calling party's call, or call content based on a keyword, password, a detection of importance or urgency, or other call description.

4. The method of claim 1 wherein the determination of the disposition of the call is based on a comparison of the obtained certain details to information that is available to, was provided to or is known by the artificial intelligence.

5. The method of claim 1 wherein the calling party is seeking to reach the particular person and the determination of call forwarding by the artificial intelligence is at least partially based on whether the particular person is available or not, wherein the call is not forwarded to the particular person by the artificial intelligence when the particular person is not available.

6. The method of claim 5 wherein the availability of the particular person is determined by a calendar, by a notification on the particular person's computer or telephone that is accessible by the artificial intelligence, by determining that the particular person is currently on a phone call, by determining that the particular person is at a particular location, by determining that the particular person is historically unavailable at the time of the received call, or by a notification to the artificial intelligence from the particular person or based on other conditions provided to the artificial intelligence prior to the call or determined by the artificial intelligence from prior call processing.

7. The method of claim 6 wherein the notification to the artificial intelligence from the particular person is through an app residing on the particular person's telephone or computer.

8. The method of claim 1 which further comprises transcribing audio between the calling party and the artificial intelligence into text and forwarding the text in real time to the particular person to allow the person to assist the artificial intelligence in processing the call.

9. The method of claim 1 wherein the determination of call forwarding to the particular person when the particular person is available, is based on obtaining details that include detecting an elevated importance in the call from the calling party.

10. The method of claim 9 wherein the detecting of the elevated importance is based on a keyword within the text which has been pre-designated as a keyword which indicates elevated importance, or is based on voice or speech recognition which includes caller tone or speed of speech above a pre-defined threshold indicating the elevated importance or is detected by the artificial intelligence determining through semantic analysis that elevated importance exists.

11. The method of claim 10, wherein when elevated importance is detected and the particular person is known to the artificial intelligence to be available, the artificial intelligence automatically forwards the call to the particular person, and when elevated importance is not detected, the artificial intelligence does not forward the call to the particular person.

12. The method of claim 1 which further comprises the artificial intelligence forwarding an intent to forward the call to a bidirectional transceiver associated with the particular person; and receiving data from the particular person indicating that the particular person is not available or does not wish to receive the call; wherein the artificial intelligence then denies forwarding the call to the particular person.

13. The method of claim 1 wherein the call is determined to be from an authorized calling party based on caller identification information or by artificial intelligence conversations with the calling party, and wherein the call is forwarded to the particular person when the person is available.

14. The method of claim 1 wherein the call is determined to be from an unauthorized calling party based on a match of caller identification information or on the separate call processing criteria that is provided to the artificial intelligence, wherein the artificial intelligence terminates the call, forwards the call to voice mail or takes a message.

15. The method of claim 1, which further comprises recording audio between the artificial intelligence and the calling party, or generating a transcript of the audio which is forwarded to the particular person for present or future action in deciding whether to answer or return the call or not or take other action.

16. The method of claim 1 which further comprises forwarding in real time some or all of the obtained certain details to the particular person; wherein the particular person can override the determination made by the artificial intelligence based on a review of the forwarded details that are provided in real time to the particular person.

17. The method of claim 1 which further comprises:
forwarding in real time some or all of the obtained certain details to a monitoring person;
wherein the monitoring person can assist the artificial intelligence in obtaining details or making the determination by communicating with the artificial intelligence so that the call may be properly processed.

18. A network switch, comprising:
at least one phone network interface which receives phone calls at a first network node;
a physical storage medium which stores audio from the phone calls;
a speech recognition engine which transcribes at least some of the audio from the phone calls;
a transcription engine which transcribes at least some of the audio from the phone calls;
a packet-switched data network connection which transmits audio output of at least one of:
text to speech synthesis; and
pre-recorded audio to a calling party of the telephone call;
wherein the audio output comprises responses based on output of the transcription engine; and
while transcribing the at least some of the audio of the telephone call, sending the transcription to a bidirectional transceiver at a second network node in real-time.

19. The network switch of claim 18, wherein the audio output is based partially on artificial intelligence and partially on instructions received from the bidirectional transceiver receiving the transcription; wherein data are transmitted via the packet-switched data network to the bidirectional transceiver causing a plurality of selectable elements to be exhibited on the bidirectional transceiver, wherein the selectable elements are based on preceding conversation between the calling party and the artificial intelligence.

20. The network switch of claim 19, wherein a selectable element of the selectable elements comprises at least one selector which, when selected, causes the call to be forwarded to another network node or particular person; causes future calls from the calling party received at the first network node to be forwarded to the bidirectional transceiver, bypassing the step of the creating the transcription; causes future calls from the calling party to carry out the step of the receiving the phone call at the first network node and the using speech recognition while skipping or suppressing the step of sending the transcription to the bidirectional transceiver; or comprise selections related to time.

21. The network switch of claim 18, wherein text input from the bidirectional transceiver is received via the packet-switched data network connection; and plays a speech synthesized version of the text input as part of the audio output, or converts the audio input to text and a speech synthesized version of the audio input, based on the text, is exhibited over the phone network, such that the speech synthesized version matches a voice of the speech synthesis in the audio output.

22. A telephone switch comprising at least one telephone network node and at least one network connection with a bidirectional transceiver, which:
receives a phone call at the at least one network node;
uses speech recognition to create a transcription of audio of the telephone call;
while creating the transcription of audio of the telephone call, sends the transcription to the bidirectional transceiver in real-time via the at least one network connection;
during said phone call, transmits audio output of at least one of text to speech synthesis or pre-recorded audio to a calling party via said at least one network node based on information provided by the calling party and instructions received from said bidirectional transceiver receiving said transcription; and
directs the call or responds to the calling party based on the information provided by the calling party and instructions received from said bidirectional transceiver.

23. The telephone switch of claim 22, wherein using the speech recognition, a processor on the telephone switch determines that the calling party wants to schedule a meeting, and the instructions received from the bidirectional transceiver include a date and time for the meeting.

24. The telephone switch of claim 22, wherein the instructions received from the bidirectional transceiver indicate that a particular person is unavailable and a proposed time for the particular person to place a new telephone call to the calling party, the instructions further comprising the proposed new time.

25. The telephone switch of claim 22, wherein the bidirectional transceiver, while receiving the transcription:
(a) sends instructions to the first network node to end the telephone call; and the telephone call is disconnected from the first network node; or
(b) sends instructions to the first network node to forward the phone call to the called party or a third party.
